(19) United States
(12) Patent Application Publication
(10) Pub. No.: US 2015/0093693 A1
(43) Pub. Date: Apr. 2, 2015

(54) ELECTROPHOTOGRAPHIC PHOTOSENSITIVE MEMBER, PROCESS CARTRIDGE AND ELECTROPHOTOGRAPHIC APPARATUS

(71) Applicant: CANON KABUSHIKI KAISHA, Tokyo (JP)

(72) Inventors: Kaname Watariguchi, Yokohama-shi (JP); Masato Tanaka, Tagata-gun (JP)

(21) Appl. No.: 14/476,356

(22) Filed: Sep. 3, 2014

(30) Foreign Application Priority Data
Sep. 30, 2013 (JP) 2013-204604

(51) Int. Cl. G03G 15/00

(52) U.S. Cl. CPC G03G 5/0638; G03G 5/0696; G03G 5/0637
USPC 430/56; 430/58.5

(57) ABSTRACT

An electrophotographic photosensitive member, including a support, a charge generating layer on the support, and a charge transporting layer on the charge generating layer, wherein the charge generating layer includes a gallium phthalocyanine crystal, a nitrogen-containing heterocyclic compound having a nitrogen atom having a substituent, and a compound represented by Formula (1) or (2).

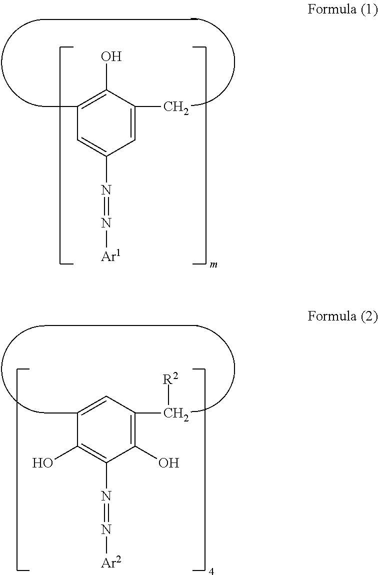

### BACKGROUND OF THE INVENTION

1. Field of the Invention

The present invention relates to an electrophotographic photosensitive member, and a process cartridge and an electrophotographic apparatus including an electrophotographic photosensitive member.

2. Description of the Related Art

Image exposing units in the electrophotographic field often use semiconductor lasers having a long emission wavelength of 650 to 820 nm, and electrophotographic photosensitive members highly sensitive to light at the long wavelength have been currently developed. Also, electrophotographic photosensitive members highly sensitive to light emitted from semiconductor lasers having a short emission wavelength have been recently developed for high resolution.

Phthalocyanine pigments used as a material for the electrophotographic photosensitive member are known as a charge generating substance highly sensitive to light from the long wavelength range to the short wavelength range. In particular, oxytitanium phthalocyanine and gallium phthalocyanine have high sensitivity, and a variety of crystal forms thereof have been reported.

Unfortunately, the electrophotographic photosensitive member containing a gallium phthalocyanine pigment has high sensitivity while its dispersibility of pigment particles may be insufficient, which leads to difficulties in attaining a coating solution for a charge generating layer having high applicability.

Specific examples of problems on the applicability of the coating solution for a charge generating layer can include phenomena causing spots (blue spots) generated in a charge generating layer due to aggregation of pigment particles during application, and an uneven coating that is likely to occur. These problems are further remarkable especially when the charge generating substance is contained in the charge generating layer in a large proportion, because the absolute amount of the resin contained in the charge generating layer is reduced. Blue spots in the charge generating layer cause black spots and fogging in an output image in particular. An uneven coating of the charge generating layer causes uneven image density in a halftone portion in particular. These reduce the quality of images.

Japanese Patent Application Laid-Open No. 2005-84350 describes a combination of gallium phthalocyanine and a specific polyvinyl alcohol that improves applicability and stability of a coating solution.

Japanese Patent Application Laid-Open No. 2001-66804 and Japanese Patent Application Laid-Open No. 2002-229228 describe use of an azotizing calixarene compound or a resorcinarene compound for a photosensitive layer. According to these documents, use of the arene compound improves the ghost phenomenon.

As above, various methods have been attempted to improve the electrophotographic photosensitive member.

To meet an increasing demand for higher quality of image in recent years, however, an output image of high quality without black spots, fogging, and unevenness of density is desired.

### SUMMARY OF THE INVENTION

An object of the present invention is to provide an electrophotographic photosensitive member that has no uneven coating of a charge generating layer and can output a high-quality image without black spots, fogging, and unevenness of density.

Another object of the present invention is to provide an electrophotographic apparatus and a process cartridge including the electrophotographic photosensitive member.

The present invention is an electrophotographic photosensitive member comprising:

a support;

a charge generating layer on the support; and

a charge transporting layer on the charge generating layer,

wherein the charge generating layer comprises:

a gallium phthalocyanine crystal;

a nitrogen-containing heterocyclic compound; and

a compound represented by Formula (1) or a compound represented by Formula (2);

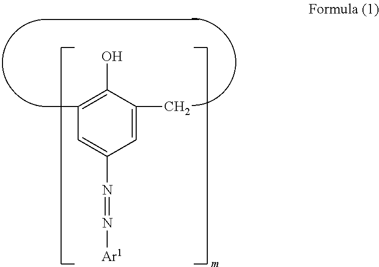

wherein,

m represents an integer of 4 to 8;

m pieces of Ar¹ may be identical or different from each other, and represent a substituted or unsubstituted aromatic hydrocarbon ring, a substituted or unsubstituted heterocyclic ring, or a monovalent group formed by bonding a plurality of groups selected from the group consisting of a substituted aromatic hydrocarbon ring, an unsubstituted aromatic hydrocarbon ring, a substituted heterocyclic ring, and an unsubstituted heterocyclic ring, or

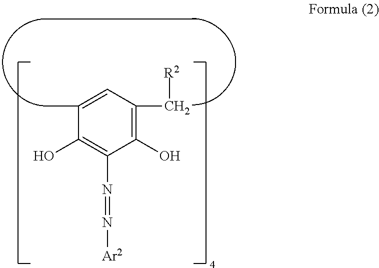

wherein,

four pieces of R² may be identical or different from each other, and represent a hydrogen atom, or a substituted or unsubstituted alkyl group;

four pieces of Ar² may be identical or different from each other, and represent a substituted or unsubstituted aromatic hydrocarbon ring, a substituted or unsubstituted heterocyclic ring, or a monovalent group formed by bonding a plurality of groups selected from the group consisting of a substituted aromatic hydrocarbon ring, an unsubstituted aromatic hydrocarbon ring, a substituted heterocyclic ring, and an unsubstituted heterocyclic ring,

and wherein a nitrogen atom in a heterocyclic ring of the nitrogen-containing heterocyclic compound has a substituent, wherein the substituent is a substituted or unsubstituted acyl group, —(C═O)—O—R¹, a substituted or unsubstituted alkyl group, a substituted or unsubstituted alkenyl group, a substituted or unsubstituted aryl group, or a substituted or unsubstituted heterocyclic group,

a substituent of the substituted acyl group is a substituted or unsubstituted alkyl group, a substituted or unsubstituted alkenyl group, a substituted or unsubstituted aryl group, or a substituted or unsubstituted heterocyclic group; R¹ represents a substituted or unsubstituted alkyl group, a substituted or unsubstituted alkenyl group, a substituted or unsubstituted aryl group, or a substituted or unsubstituted heterocyclic group; and

a substituent of the substituted alkyl group, a substituent of the substituted alkenyl group, a substituent of the substituted aryl group, and a substituent of the substituted heterocyclic group are a halogen atom, a cyano group, a nitro group, a hydroxy group, a formyl group, an alkyl group, an alkenyl group, an alkoxy group, or an aryl group.

The present invention is a process cartridge detachably mountable on a main body of an electrophotographic apparatus, the process cartridge including the electrophotographic photosensitive member, and at least one unit selected from the group consisting of a charging unit, a developing unit, a transferring unit and a cleaning unit, the electrophotographic photosensitive member and the at least one unit being integrally supported.

The present invention is an electrophotographic apparatus including the electrophotographic photosensitive member, a charging unit, an image exposing unit, a developing unit, and a transferring unit.

The present invention can provide an electrophotographic photosensitive member that has no uneven coating of a charge generating layer and can output a high-quality image without black spots, fogging, and unevenness of density and a process cartridge and an electrophotographic apparatus including the electrophotographic photosensitive member.

Further features of the present invention will become apparent from the following description of exemplary embodiments with reference to the attached drawings.

### BRIEF DESCRIPTION OF THE DRAWINGS

FIG. 1 is a drawing illustrating an example of a schematic configuration of an electrophotographic apparatus including a process cartridge including an electrophotographic photosensitive member.

FIG. 2 is a drawing illustrating the result of powder X-ray diffraction of a hydroxygallium phthalocyanine crystal prepared in Example 1-1.

FIG. 3 is a drawing illustrating the result of powder X-ray diffraction of a hydroxygallium phthalocyanine crystal prepared in Example 1-2.

FIG. 4 is a drawing illustrating the result of powder X-ray diffraction of a hydroxygallium phthalocyanine crystal prepared in Example 1-6.

### DESCRIPTION OF THE EMBODIMENTS

Preferred embodiments of the present invention will now be described in detail in accordance with the accompanying drawings.

The electrophotographic photosensitive member according to the present invention is an electrophotographic photosensitive member including a support; a charge generating layer on the support; and a charge transporting layer on the charge generating layer,

wherein the charge generating layer includes:
a gallium phthalocyanine crystal;
a nitrogen-containing heterocyclic compound; and
a compound represented by Formula (1) or a compound represented by Formula (2):

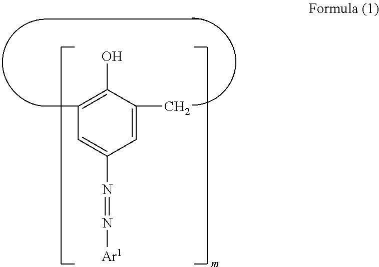

wherein m represents an integer of 4 to 8; an m pieces of Ar¹ may be identical or different from each other, and represent a substituted or unsubstituted aromatic hydrocarbon ring, a substituted or unsubstituted heterocyclic ring, or a monovalent group formed by bonding a plurality of groups selected from the group consisting of a substituted aromatic hydrocarbon ring, an unsubstituted aromatic hydrocarbon ring, a substituted heterocyclic ring and an unsubstituted heterocyclic ring, or

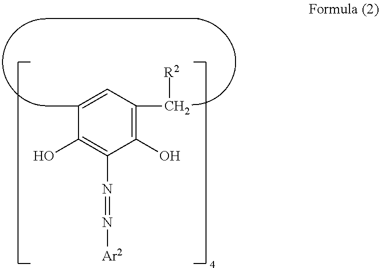

wherein four pieces of R² may be identical or different from each other, and represent a hydrogen atom, or a substituted or unsubstituted alkyl group; four pieces of Ar² may be identical or different from each other, and represent a substituted or unsubstituted aromatic hydrocarbon ring, a substituted or unsubstituted heterocyclic ring, or a monovalent group formed by bonding a plurality of groups selected from the group consisting of a substituted aromatic hydrocarbon ring, an unsubstituted aromatic hydrocarbon ring, a substituted heterocyclic ring and an unsubstituted heterocyclic ring, a nitrogen atom in a heterocyclic ring of the nitrogen-containing heterocyclic compound has a substituent, wherein the substituent is a substituted or unsubstituted acyl group, —(C═O)—O—R¹, a substituted or unsubstituted alkyl group, a substituted or unsubstituted alkenyl group, a substituted or unsubstituted aryl group, or a substituted or unsubstituted heterocyclic group,

wherein a substituent of the substituted acyl group, however, is a substituted or unsubstituted alkyl group, a substituted or unsubstituted alkenyl group, a substituted or unsubstituted aryl group, or a substituted or unsubstituted heterocyclic group; R¹ represents a substituted or unsubstituted alkyl group, a substituted or unsubstituted alkenyl group, a substituted or unsubstituted aryl group, or a substituted or unsubstituted heterocyclic group; and
a substituent of the substituted alkyl group, a substituent of the substituted alkenyl group, a substituent of the substituted aryl group and a substituent of the substituted heterocyclic group are a halogen atom, a cyano group, a nitro group, a hydroxy group, a formyl group, an alkyl group, an alkenyl group, an alkoxy group or an aryl group.

The nitrogen-containing heterocyclic compound can be pyrrole, pyrrolidine, morpholine, piperazine, piperidine, 4-piperidone, indole, phenothiazine, phenoxazine or carbazole. Among these, morpholine, piperazine, piperidine, 4-piperidone and indole are more preferable.

Examples of the substituent bonding to an atom other than a nitrogen atom (such as a carbon atom) forming the ring of the nitrogen-containing heterocyclic compound include the followings. Namely, a hydrogen atom, a substituted or unsubstituted alkyl group, a substituted or unsubstituted aryl group, a substituted or unsubstituted heterocyclic group, a halogen atom, a hydroxy group, a formyl group, an alkenyl group, an alkoxy group or an alkyloxycarbonyl group can be used.

At this time, a substituent of the substituted alkyl group, a substituent of the substituted aryl group and a substituent of the substituted heterocyclic group are more preferably a halogen atom, a hydroxy group or a formyl group.

From the viewpoint of effectiveness of suppressing black spots, fogging, and unevenness of density of a charge generating layer, particularly preferable nitrogen-containing heterocyclic compounds are nitrogen-containing heterocyclic compounds represented by Formulae (3) to (7):

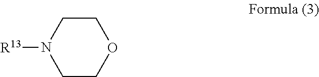

wherein R¹³ represents a substituted or unsubstituted acyl group, —(C═O)—O—R¹¹, a substituted or unsubstituted alkyl group, a substituted or unsubstituted alkenyl group, a substituted or unsubstituted aryl group, or a substituted or unsubstituted heterocyclic group; a substituent of the substituted acyl group is a substituted or unsubstituted alkyl group, a substituted or unsubstituted alkenyl group, a substituted or unsubstituted aryl group, or a substituted or unsubstituted heterocyclic group; R¹¹ represents a substituted or unsubstituted alkyl group, a substituted or unsubstituted alkenyl group, a substituted or unsubstituted aryl group, or a substituted or unsubstituted heterocyclic group.

A substituent of the substituted alkyl group, a substituent of the substituted alkenyl group, a substituent of the substituted aryl group and a substituent of the substituted heterocyclic group are more preferably a halogen atom, a cyano group, a nitro group, a hydroxy group, a formyl group, an alkyl group, an alkenyl group, an alkoxy group or an aryl group.

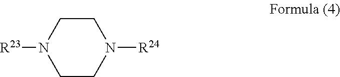

wherein R²³ and R²⁴ each independently represent a substituted or unsubstituted acyl group, —(C═O)—O—R²¹, a substituted or unsubstituted alkyl group, a substituted or unsubstituted alkenyl group, a substituted or unsubstituted aryl group, or a substituted or unsubstituted heterocyclic group; a substituent of the substituted acyl group is a substituted or unsubstituted alkyl group, a substituted or unsubstituted alkenyl group, a substituted or unsubstituted aryl group, or a substituted or unsubstituted heterocyclic group; R²¹ represents a substituted or unsubstituted alkyl group, a substituted or unsubstituted alkenyl group, a substituted or unsubstituted aryl group, or a substituted or unsubstituted heterocyclic group.

A substituent of the substituted alkyl group, a substituent of the substituted alkenyl group, a substituent of the substituted aryl group and the substituent of the substituted heterocyclic group are more preferably a halogen atom, a cyano group, a nitro group, a hydroxy group, a formyl group, an alkyl group, an alkenyl group, an alkoxy group or an aryl group.

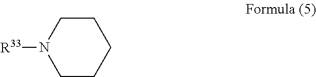

wherein R³³ represents a substituted or unsubstituted acyl group, —(C═O)—O—R³¹, a substituted or unsubstituted alkyl group, a substituted or unsubstituted alkenyl group, a substituted or unsubstituted aryl group, or a substituted or unsubstituted heterocyclic group; a substituent of the substituted acyl group is a substituted or unsubstituted alkyl group, a substituted or unsubstituted alkenyl group, a substituted or unsubstituted aryl group, or a substituted or unsubstituted heterocyclic group; and R³¹ represents a substituted or unsubstituted alkyl group, a substituted or unsubstituted alkenyl group, a substituted or unsubstituted aryl group, or a substituted or unsubstituted heterocyclic group.

A substituent of the substituted alkyl group, a substituent of the substituted alkenyl group, a substituent of the substituted aryl group and a substituent of the substituted heterocyclic group are more preferably a halogen atom, a cyano group, a nitro group, a hydroxy group, a formyl group, an alkyl group, an alkenyl group, an alkoxy group or an aryl group.

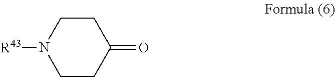

wherein R⁴³ represents a substituted or unsubstituted acyl group, —(C═O)—O—R⁴¹, a substituted or unsubstituted alkyl group, a substituted or unsubstituted alkenyl group, a substituted or unsubstituted aryl group, or a substituted or unsubstituted heterocyclic group; a substituent of the substituted acyl group is a substituted or unsubstituted alkyl group, a substituted or unsubstituted alkenyl group, a substituted or unsubstituted aryl group, or a substituted or unsubstituted heterocyclic group; and R⁴¹ represents a substituted or unsubstituted alkyl group, a substituted or unsubstituted alkenyl group, a substituted or unsubstituted aryl group, or a substituted or unsubstituted heterocyclic group.

A substituent of the substituted alkyl group, a substituent of the substituted alkenyl group, a substituent of the substituted aryl group and a substituent of the substituted heterocyclic group are more preferably a halogen atom, a cyano group, a nitro group, a hydroxy group, a formyl group, an alkyl group, an alkenyl group, an alkoxy group or an aryl group.

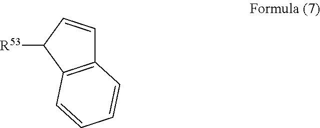

wherein R⁵³ represents a substituted or unsubstituted acyl group, —(C═O)—O—R⁵¹, a substituted or unsubstituted alkyl group, a substituted or unsubstituted alkenyl group, a substituted or unsubstituted aryl group, or a substituted or unsubstituted heterocyclic group; a substituent of the substituted acyl group is a substituted or unsubstituted alkyl group, a substituted or unsubstituted alkenyl group, a substituted or unsubstituted aryl group, or a substituted or unsubstituted heterocyclic group; R⁵¹ represents a substituted or unsubstituted alkyl group, a substituted or unsubstituted alkenyl group, a substituted or unsubstituted aryl group, or a substituted or unsubstituted heterocyclic group.

A substituent of the substituted alkyl group, a substituent of the substituted alkenyl group, a substituent of the substituted aryl group and a substituent of the substituted heterocyclic group are more preferably a halogen atom, a cyano group, a nitro group, a hydroxy group, a formyl group, an alkyl group, an alkenyl group, an alkoxy group or an aryl group.

In Formulae (3) to (7), R¹³, R²³, R²⁴, R³³, R⁴³ and R⁵³ can each independently represent a methyl group, an ethyl group or a phenyl group.

The content of the nitrogen-containing heterocyclic compound in the charge generating layer can be 0.01% by mass or more and 20% by mass or less based on the gallium phthalocyanine crystal.

The gallium phthalocyanine crystal can be a gallium phthalocyanine crystal in which the nitrogen-containing heterocyclic compound is contained.

Now, preferable specific examples (Exemplary compounds (1) to (172)) of the nitrogen-containing heterocyclic compound contained in the electrophotographic photosensitive member according to the present invention will be shown, but the present invention will not be limited to these.

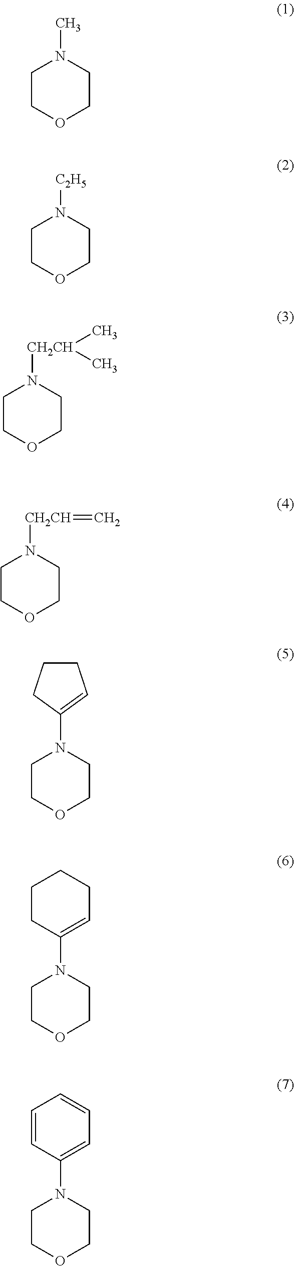

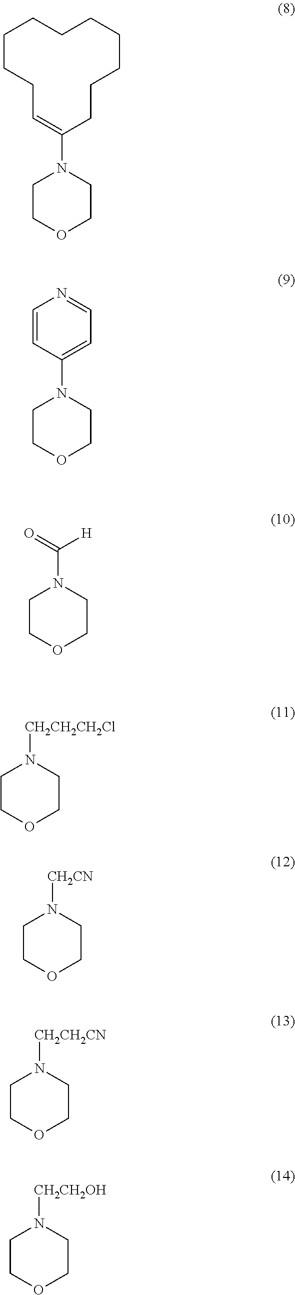

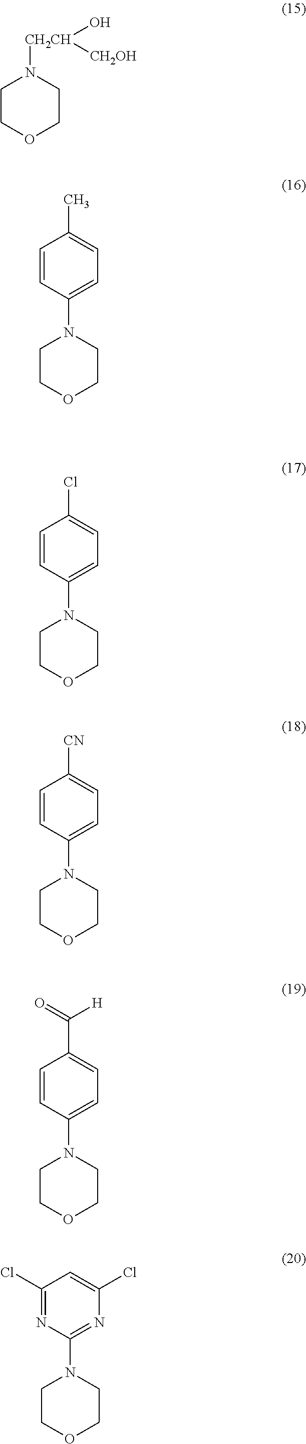

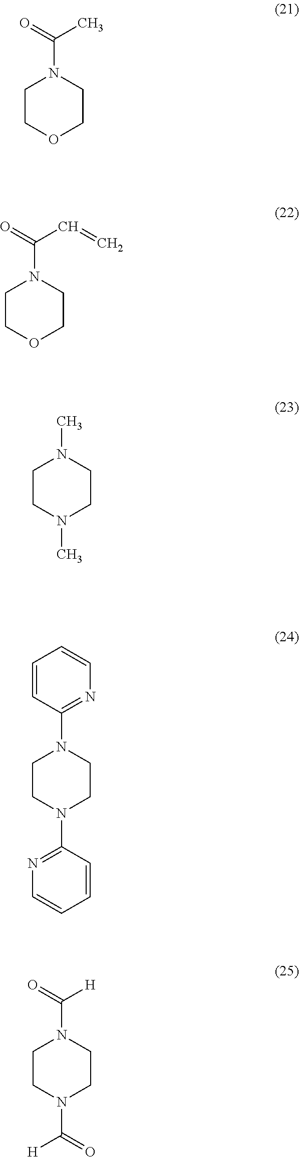

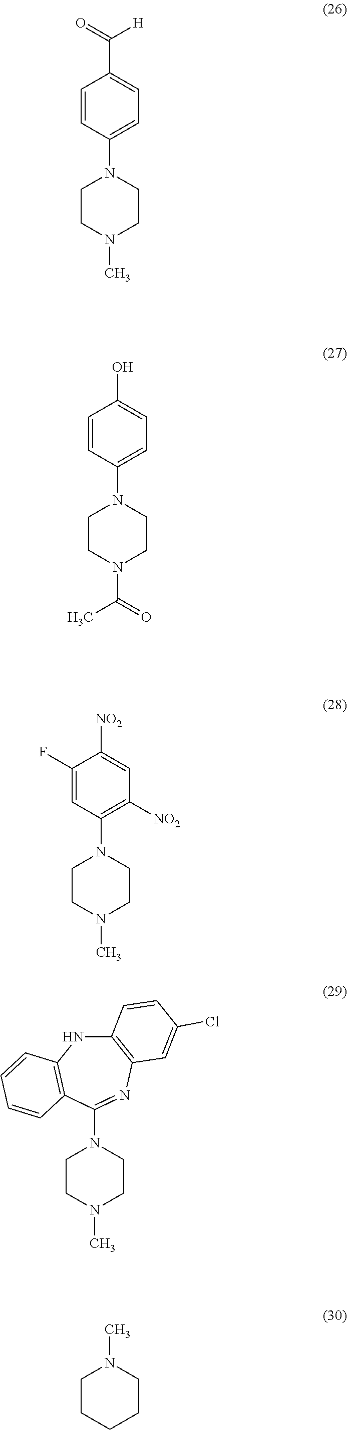

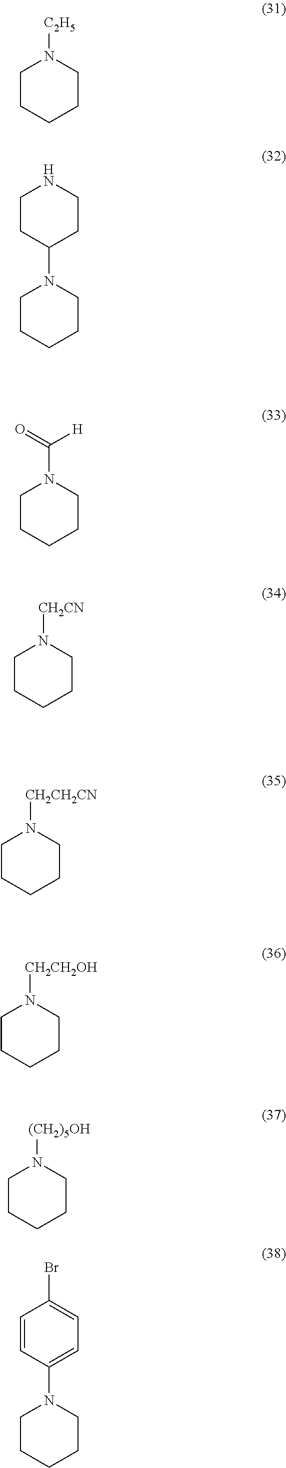

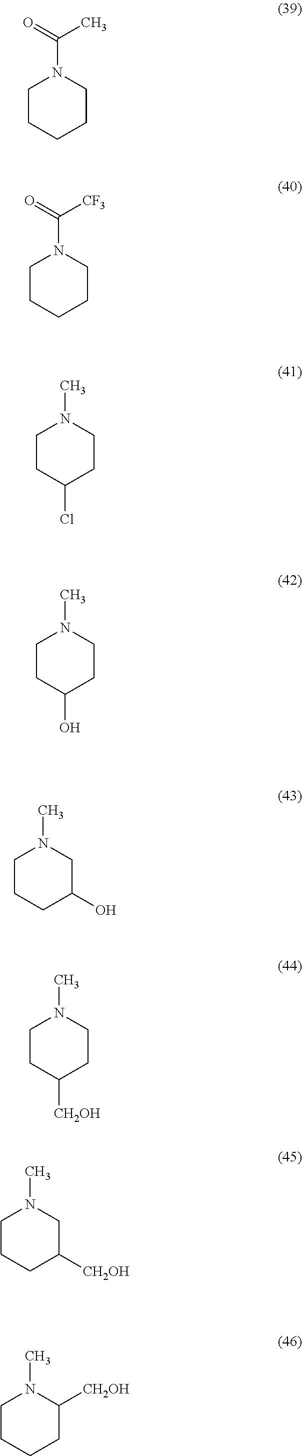

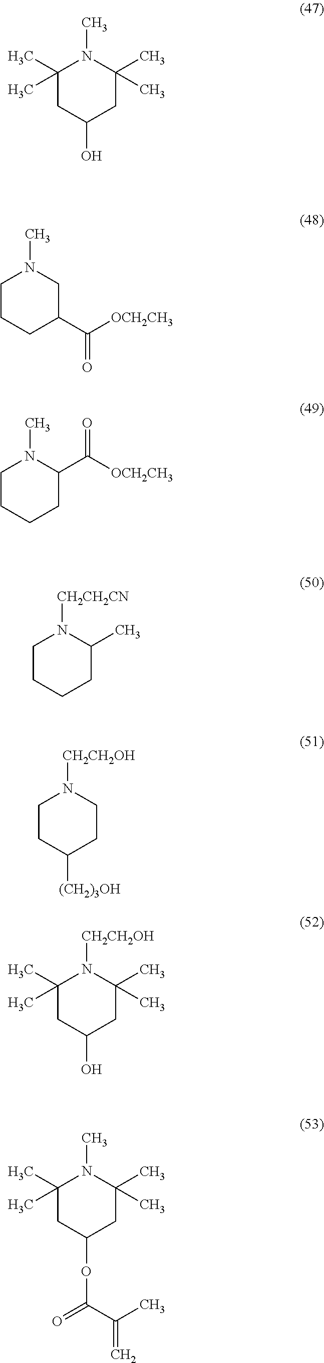

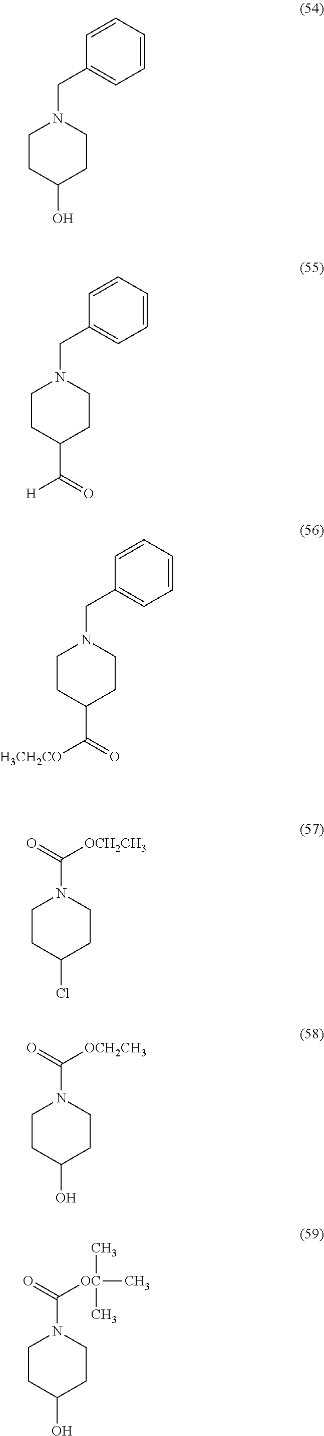

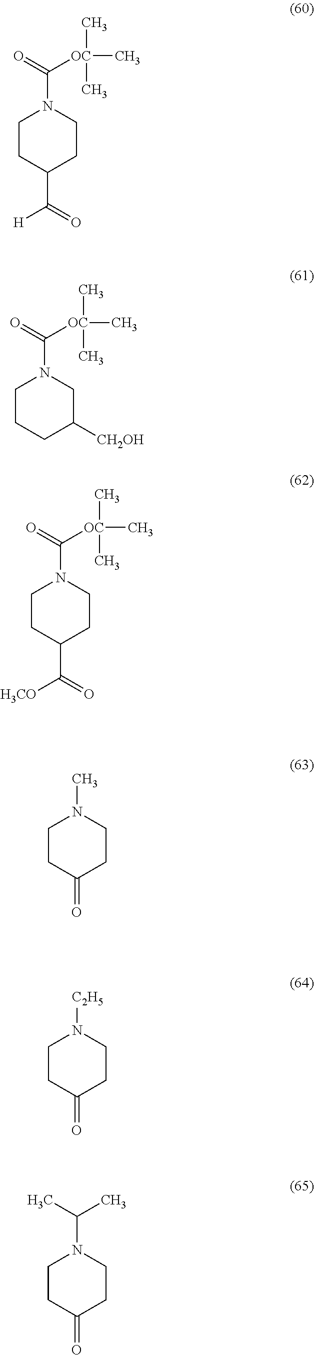

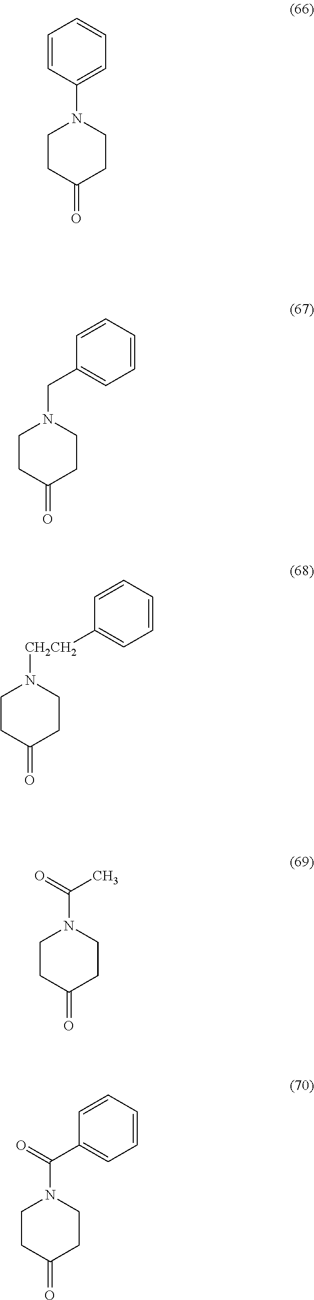

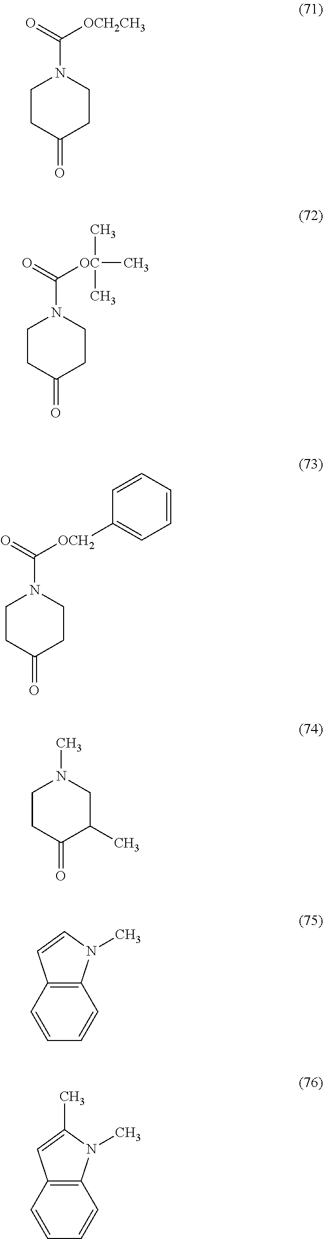

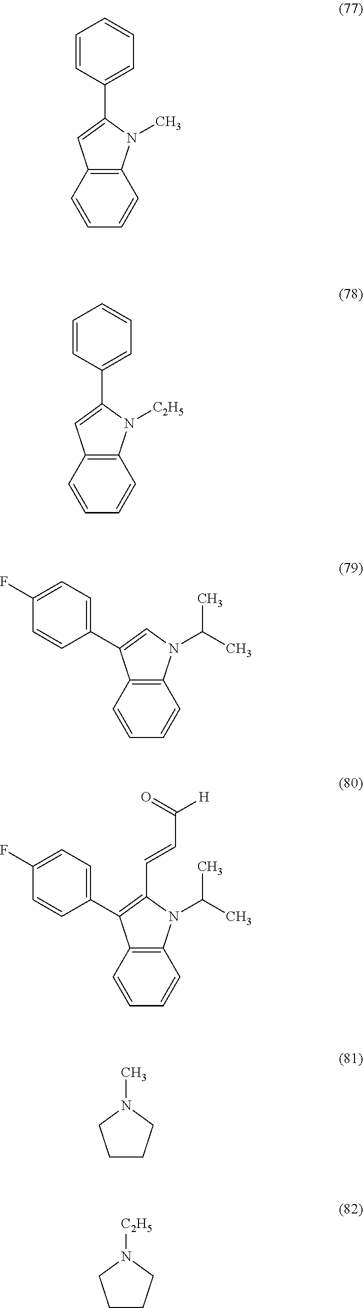

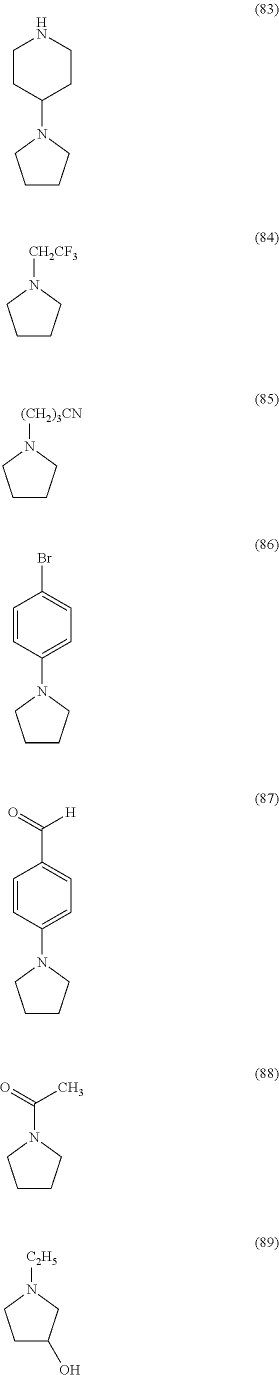

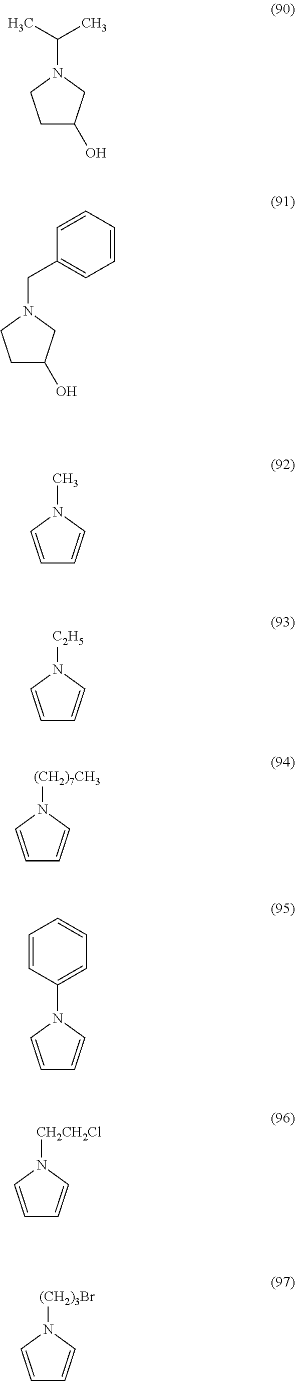

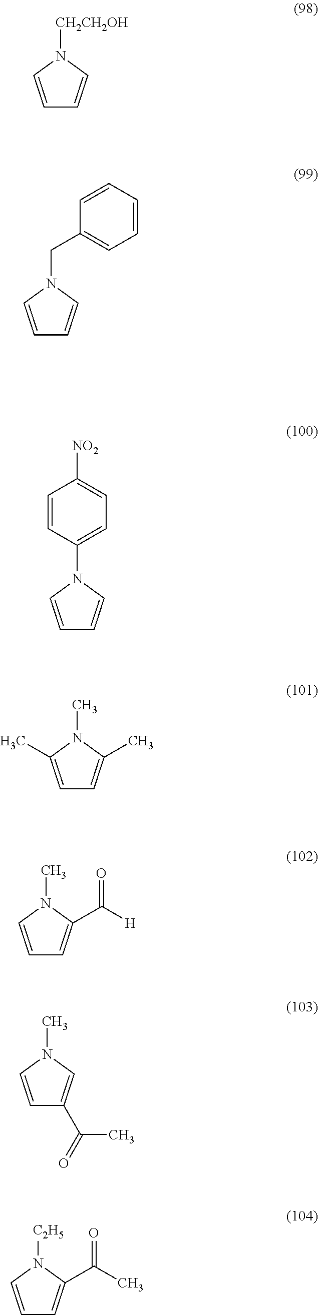

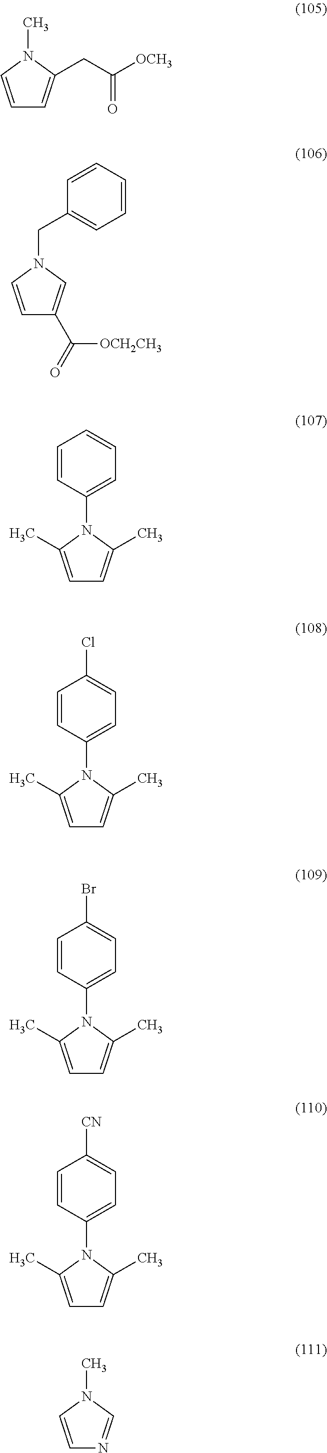

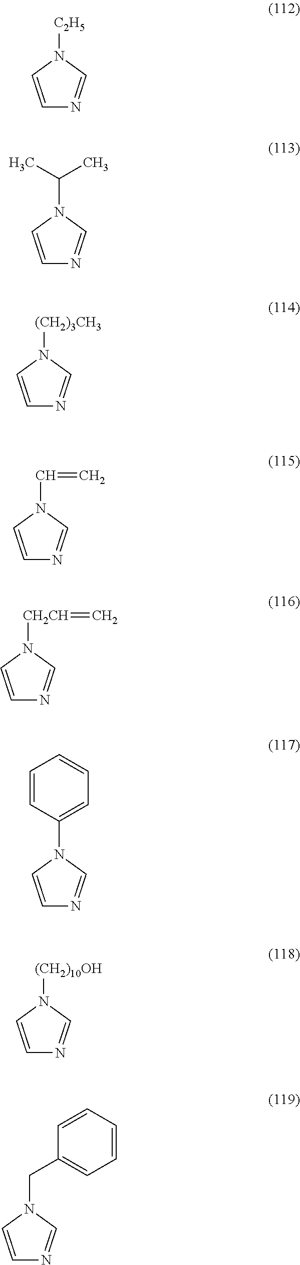

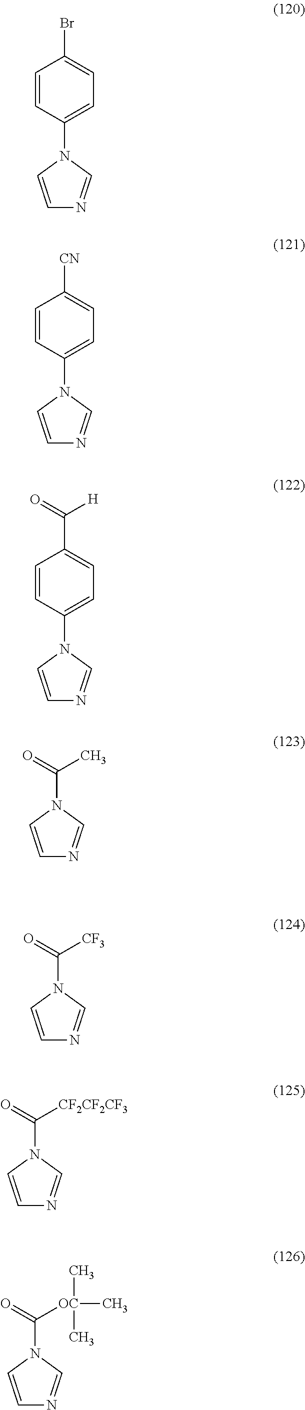

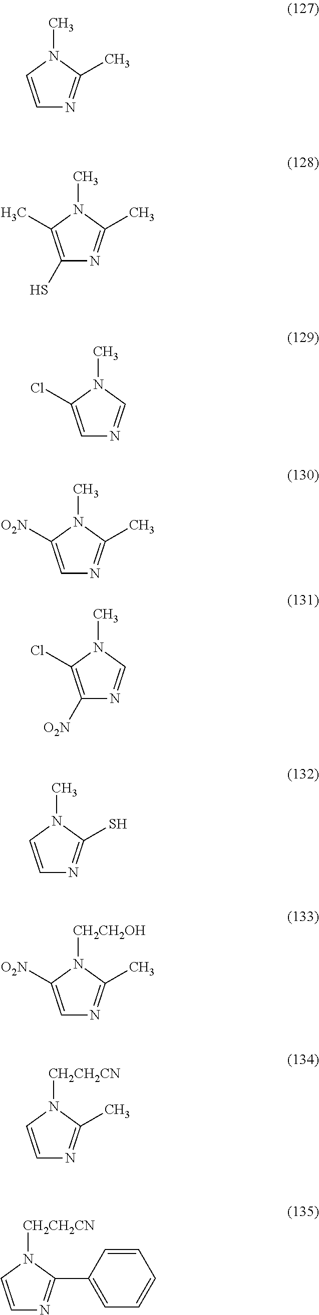

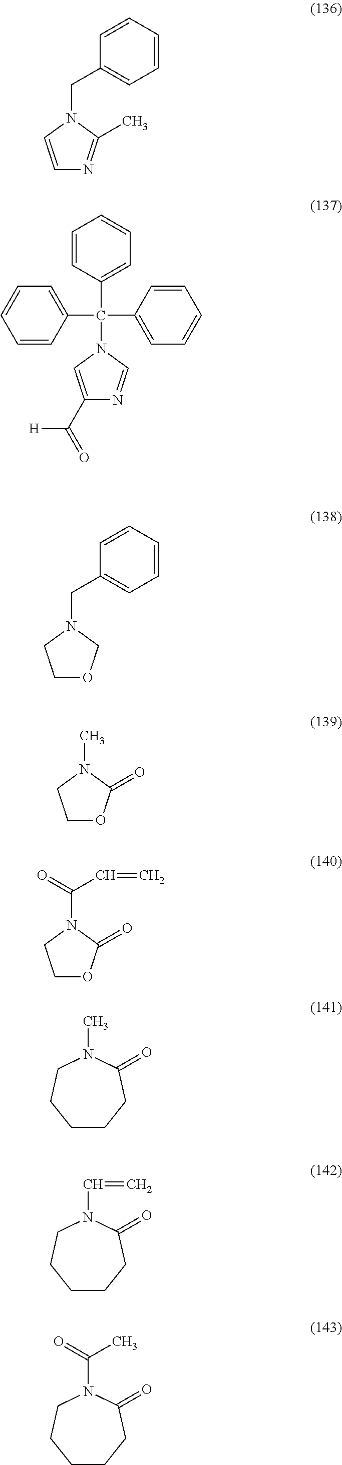

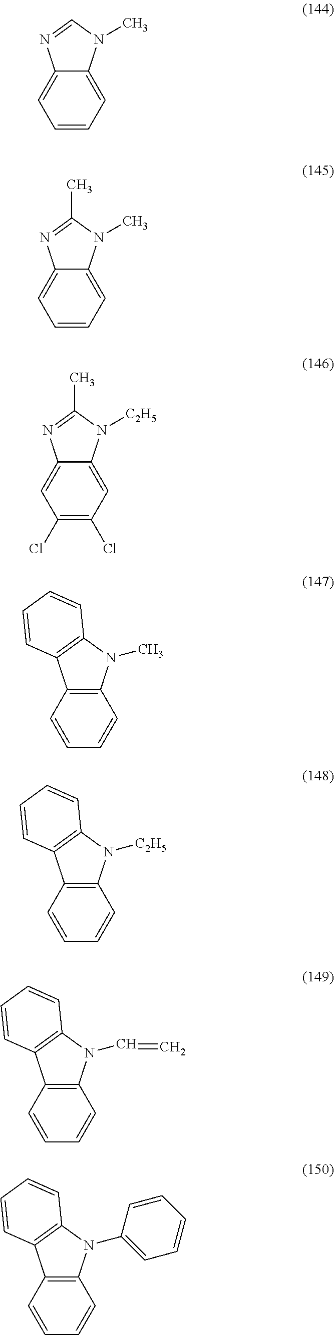

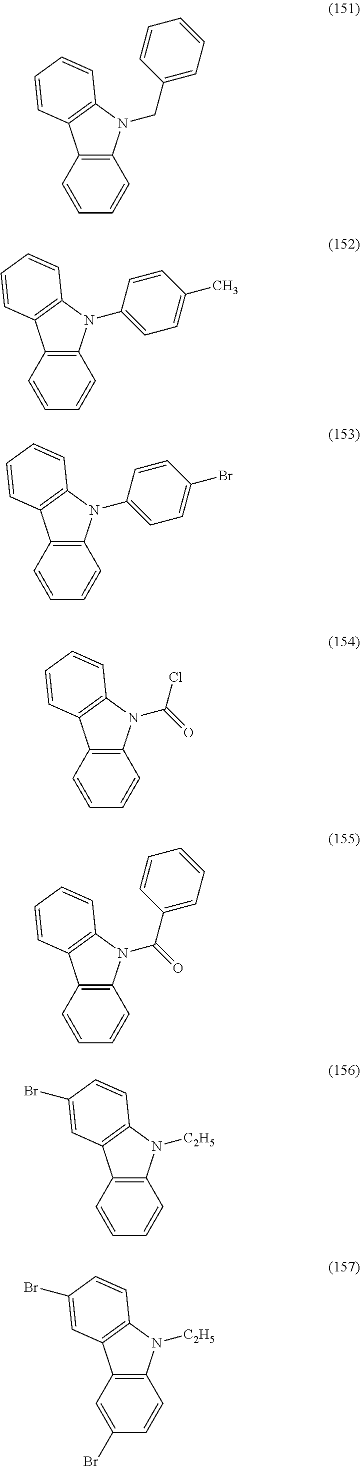

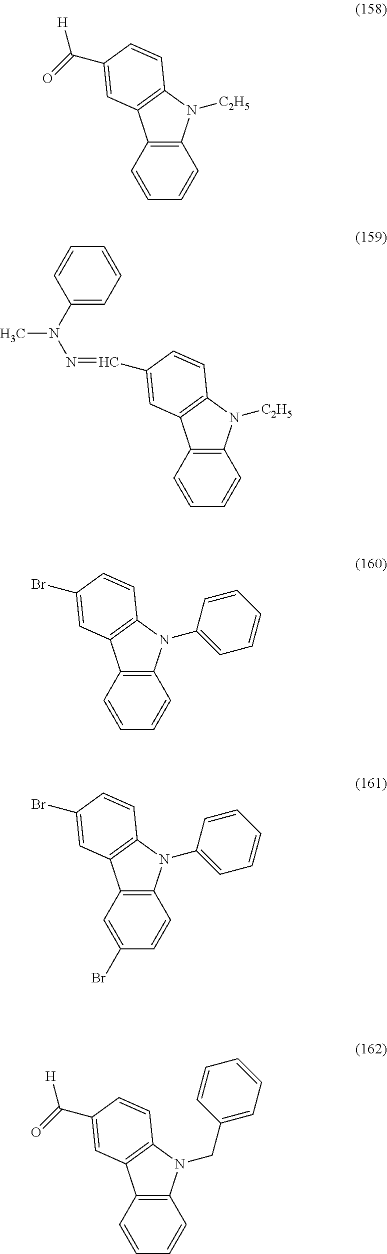 [SMILES: CCn1c2ccccc2c2cc(C=O)ccc21 ; CCn1c2ccccc2c2cc(/C=N/N(C)c3ccccc3)ccc21 ; Brc1ccc2c(c1)c1ccccc1n2-c1ccccc1 ; Brc1ccc2c(c1)c1cc(Br)ccc1n2-c1ccccc1 ; O=Cc1ccc2c(c1)c1ccccc1n2Cc1ccccc1]

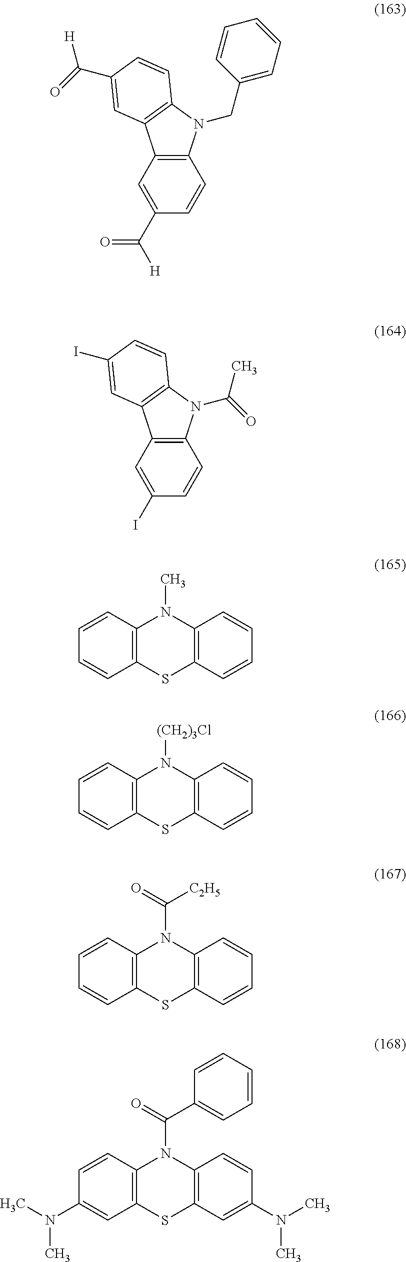

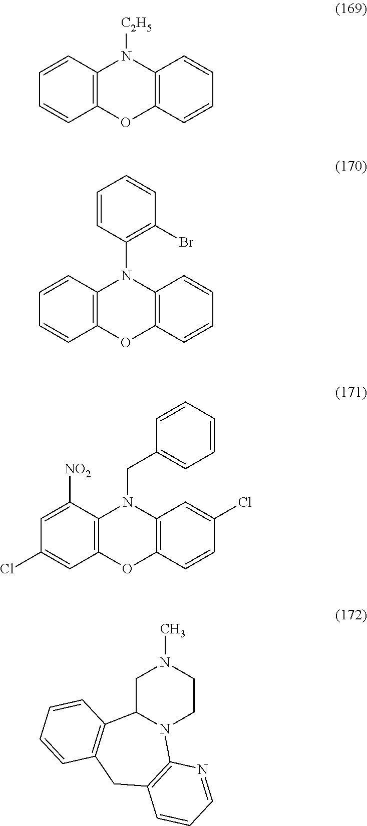 [SMILES: CCN1c2ccccc2Oc2ccccc21 ; Brc1ccccc1N1c2ccccc2Oc2ccccc21 ; O=[N+]([O-])c1cc(Cl)cc2c1N(Cc1ccccc1)c1cc(Cl)ccc1O2 ; CN1CCN2c3ncccc3Cc3ccccc3C2C1]

The content of the compound represented by Formula (1) or (2) in the charge generating layer can be 0.01% by mass or more and 5% by mass or less based on the gallium phthalocyanine crystal.

The gallium phthalocyanine crystal can be a gallium phthalocyanine crystal in which the compound represented by Formula (1) or (2) is contained.

Examples of the aromatic hydrocarbon ring in Formula (1) include benzene, naphthalene, fluorene, phenanthrene, anthracene, fluoranthene and pyrene. Examples of the heterocyclic ring in Formula (1) include furan, thiophene, pyridine, indole, benzothiazole, carbazole, benzocarbazole, acridone, dibenzothiophene, benzoxazole, benzotriazole, oxathiazole, thiazole, phenazine, cinnoline and benzocinnoline. Examples of the monovalent group formed by bonding a plurality of groups selected from the group consisting of a substituted aromatic hydrocarbon ring, an unsubstituted aromatic hydrocarbon ring, a substituted heterocyclic ring and an unsubstituted heterocyclic ring include triphenylamine, diphenylamine, N-methyldiphenylamine, biphenyl, terphenyl, binaphthyl, fluorenone, phenanthrenequinone, anthraquinone, benzanthrone, diphenyloxazole, phenylbenzoxazole, diphenylmethane, diphenylsulfone, diphenyl ether, benzophenone, stilbene, distyrylbenzene, tetraphenyl-p-phenylenediamine and tetraphenylbenzidine.

Examples of an optional substituent for the groups above in Formula (1) include alkyl groups such as methyl, ethyl, propyl and butyl; alkoxy groups such as methoxy and ethoxy; dialkylamino groups such as dimethylamino and diethylamino; alkoxycarbonyl groups such as methoxycarbonyl and ethoxycarbonyl; halogen atoms such as a fluorine atom, a chlorine atom and a bromine atom; a hydroxy group, a nitro group, a cyano group, an acetyl group or a halomethyl group.

Ar¹ in Formula (1) is preferably a phenyl group substituted with at least one group selected from the group consisting of a cyano group, a nitro group and a halogen atom. Among these, a phenyl group whose meta-position is substituted with a cyano group or a nitro group is more preferred because of its dispersion stability.

Now, preferable specific examples of the compound represented by Formula (1) and contained in the electrophotographic photosensitive member according to the present invention (Exemplary compounds (2-1) to (2-25)) will be shown, but the present invention will not be limited to these.

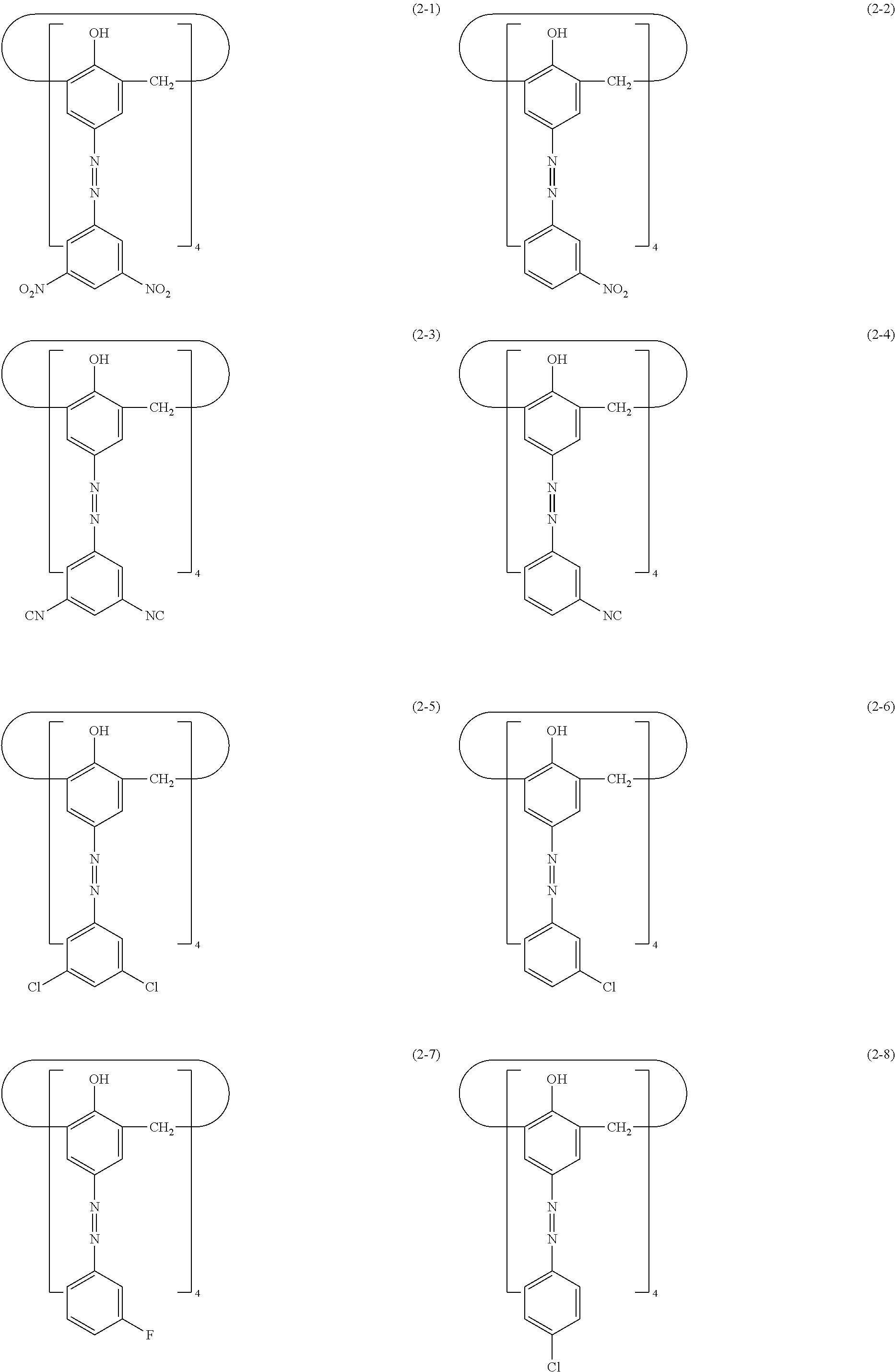

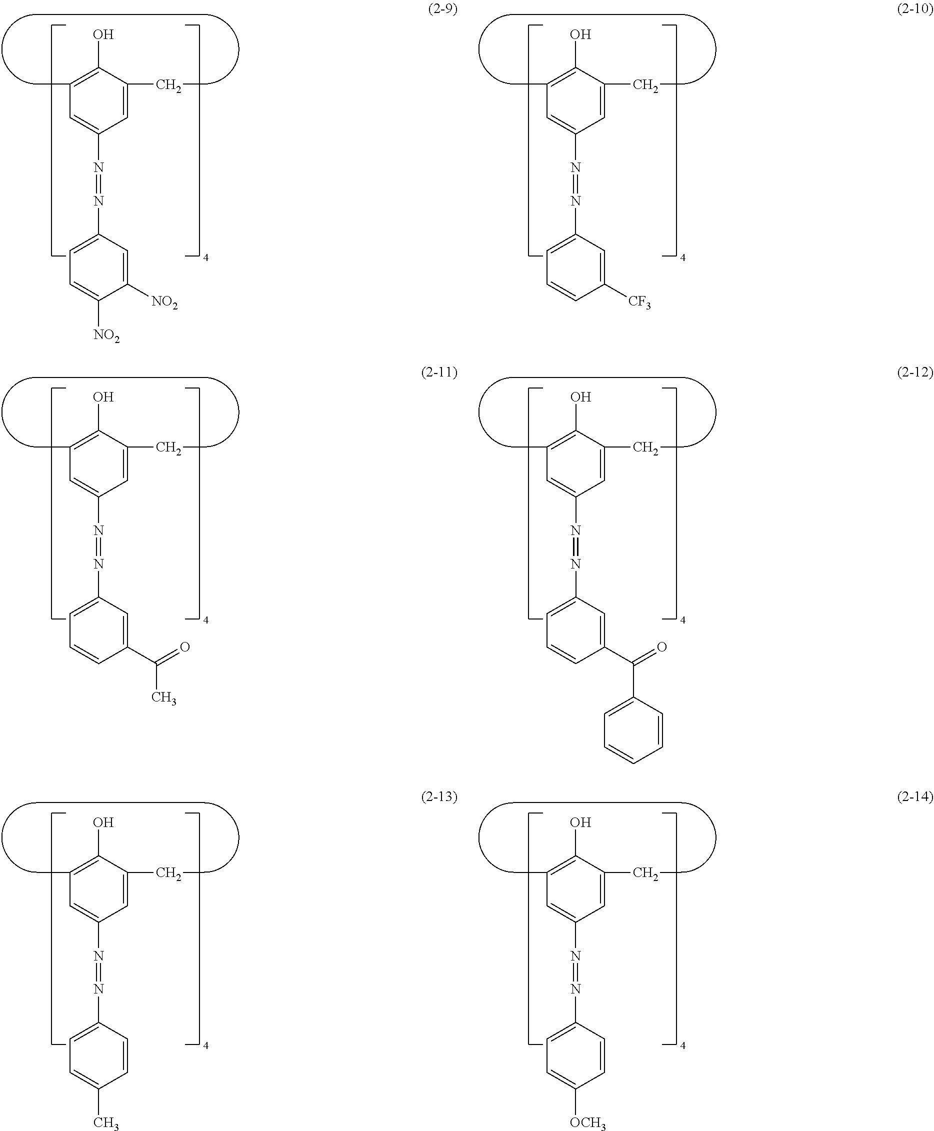

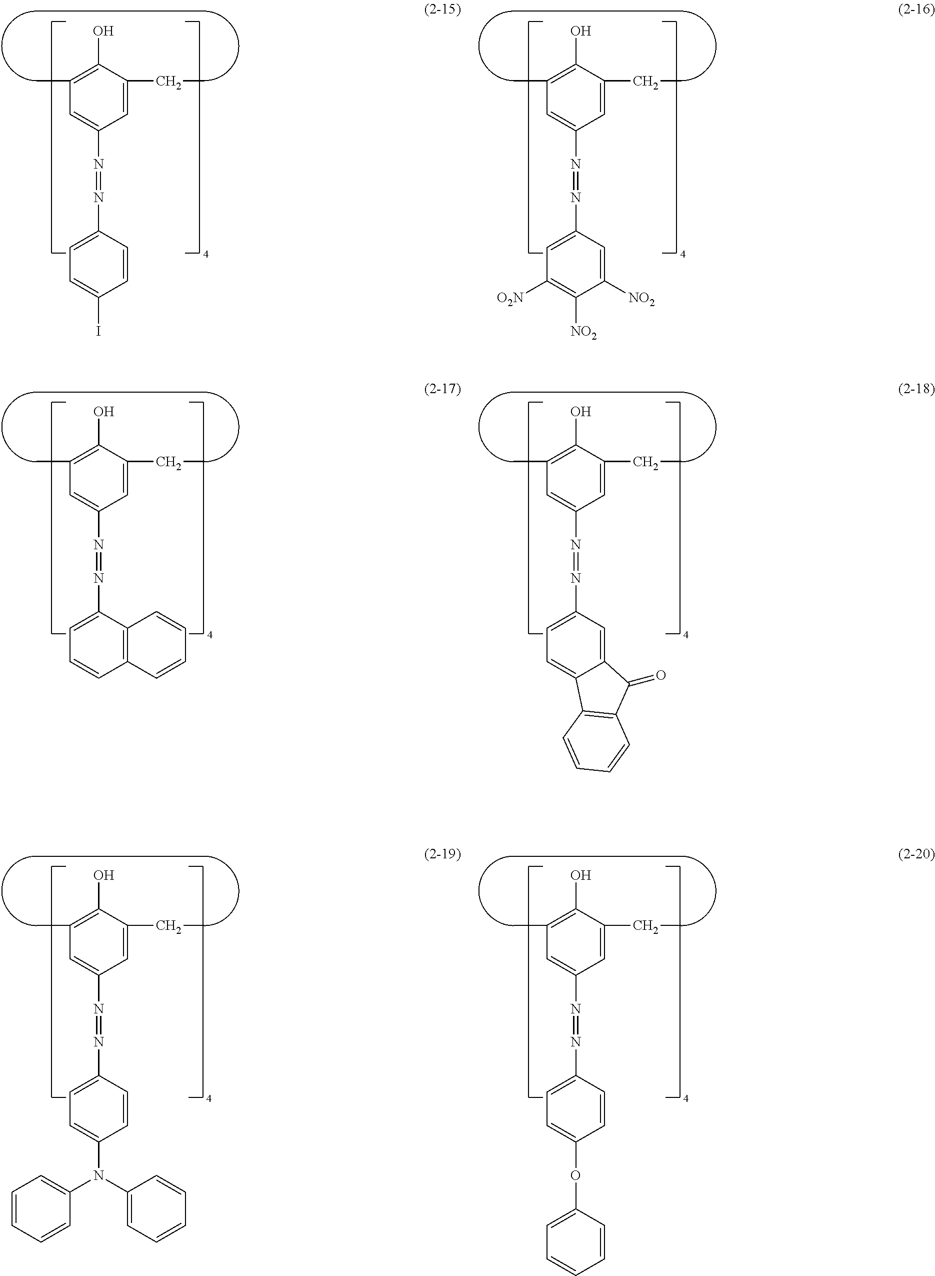

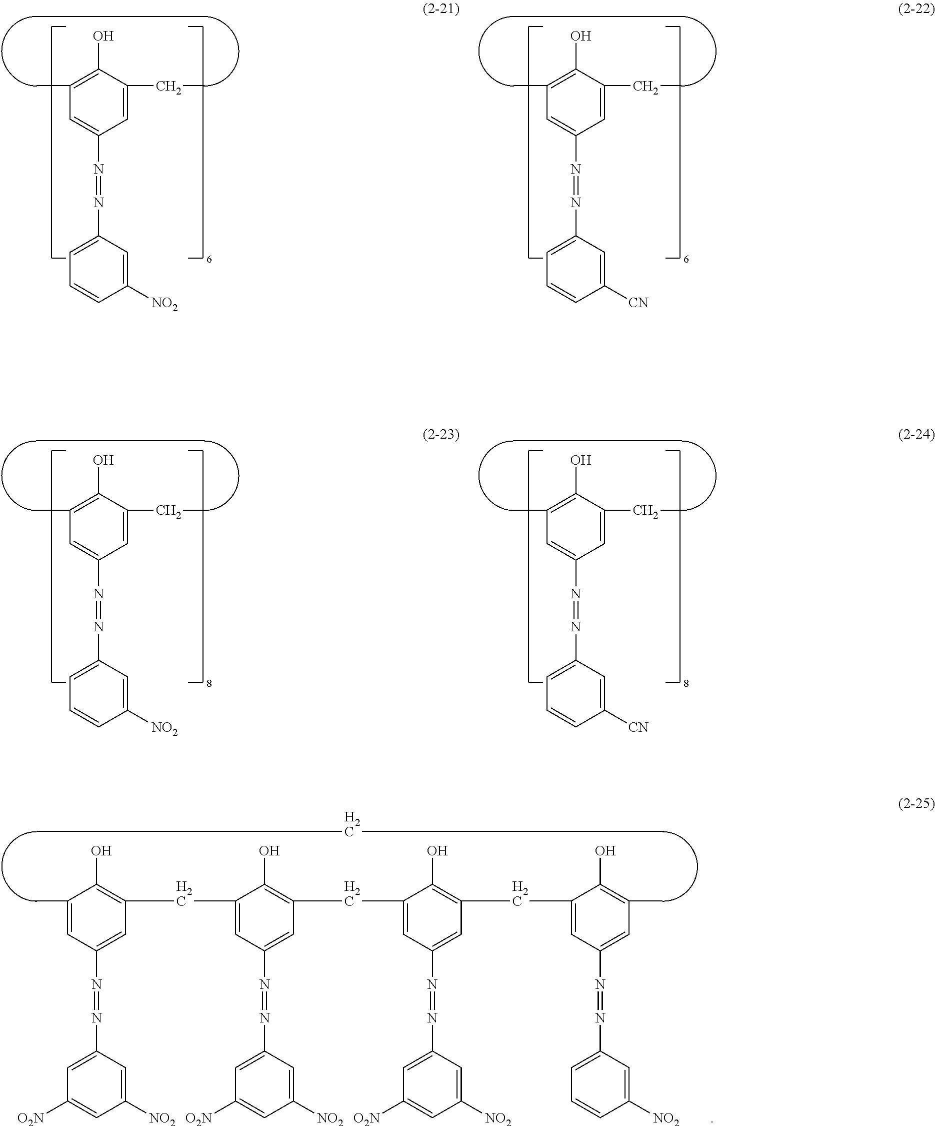

Examples of the aromatic hydrocarbon ring in Formula (2) include benzene, naphthalene, fluorene, phenanthrene, anthracene, fluoranthene and pyrene. Examples of the heterocyclic ring in Formula (2) include furan, thiophene, pyridine, indole, benzothiazole, carbazole, benzocarbazole, acridone, dibenzothiophene, benzoxazole, benzotriazole, oxathiazole, thiazole, phenazine, cinnoline and benzocinnoline. Examples of the monovalent group formed by bonding a plurality of groups selected from the group consisting of a substituted aromatic hydrocarbon ring, an unsubstituted aromatic hydrocarbon ring, a substituted heterocyclic ring and an unsubstituted heterocyclic ring include triphenylamine, diphenylamine, N-methyldiphenylamine, biphenyl, terphenyl, binaphthyl, fluorenone, phenanthrenequinone, anthraquinone, benzanthrone, diphenyloxazole, phenylbenzoxazole, diphenylmethane, diphenylsulfone, diphenyl ether, benzophenone, stilbene, distyrylbenzene, tetraphenyl-p-phenylenediamine and tetraphenylbenzidine.

Examples of the alkyl group for R² in Formula (2) include a methyl group, an ethyl group, a propyl group, a butyl group, a hexyl group, an undecyl group and a tridecyl group.

Examples of an optional substituent for the groups above in Formula (2) include alkyl groups such as methyl, ethyl, propyl and butyl; alkoxy groups such as methoxy and ethoxy; dialkylamino groups such as dimethylamino and diethylamino; alkoxycarbonyl groups such as methoxycarbonyl and ethoxycarbonyl; halogen atoms such as a fluorine atom, a chlorine atom and a bromine atom; a hydroxy group, a nitro group, a cyano group, an acetyl group or a halomethyl group.

Ar² in Formula (2) is preferably a phenyl group substituted with at least one group selected from the group consisting of a cyano group, a nitro group and a halogen atom. Among these, a phenyl group whose meta-position is substituted with a cyano group or a nitro group is more preferred because of its dispersion stability.

Now, preferable specific examples of the compound represented by Formula (2) and contained in the electrophotographic photosensitive member according to the present invention (Exemplary compounds (3-1) to (3-30) will be shown, but the present invention will not be limited to these.

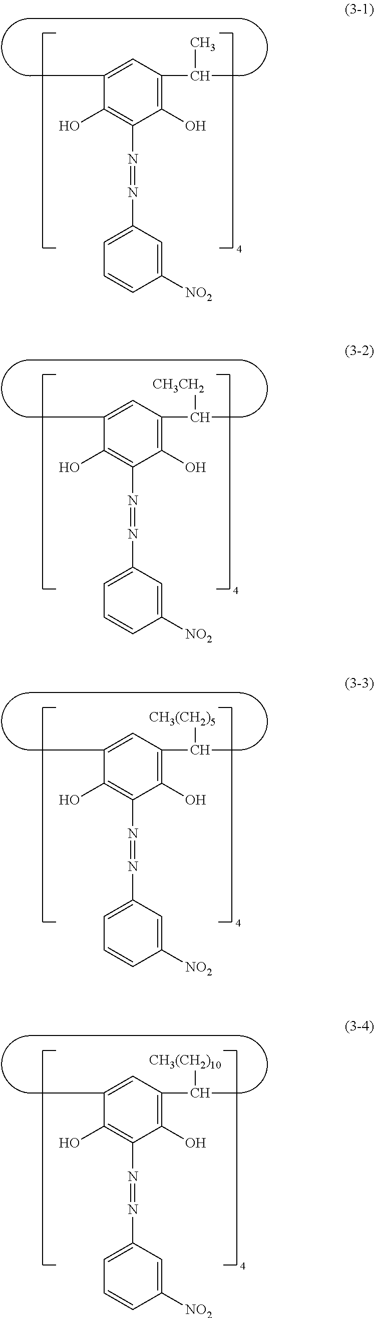

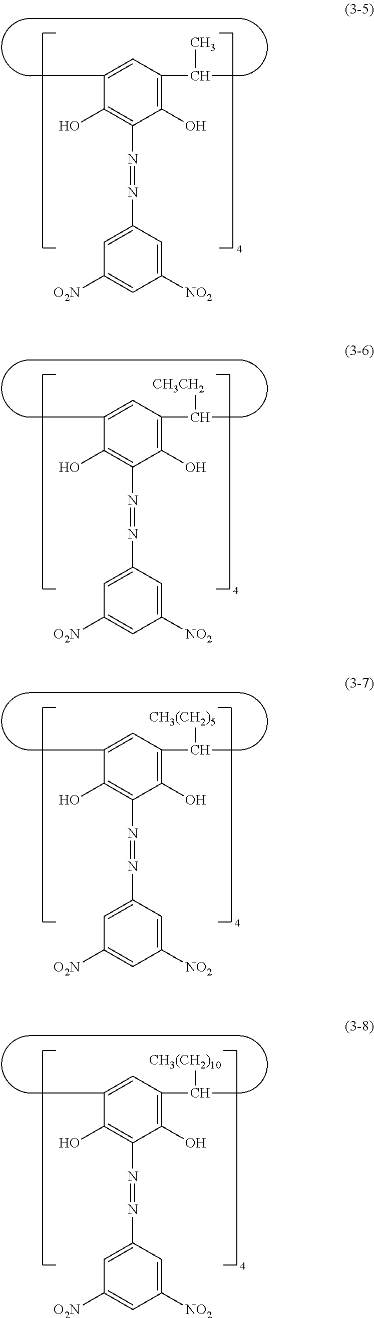

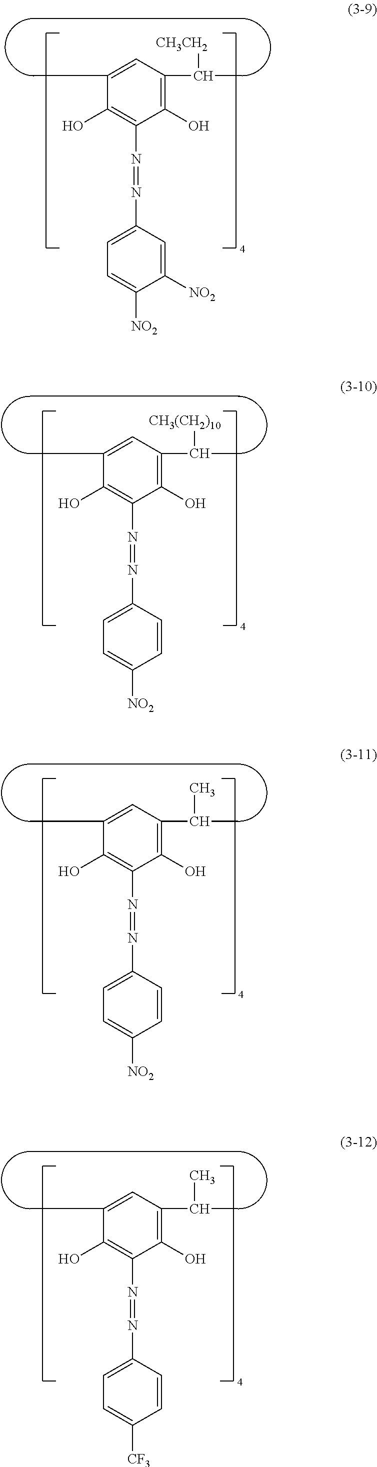

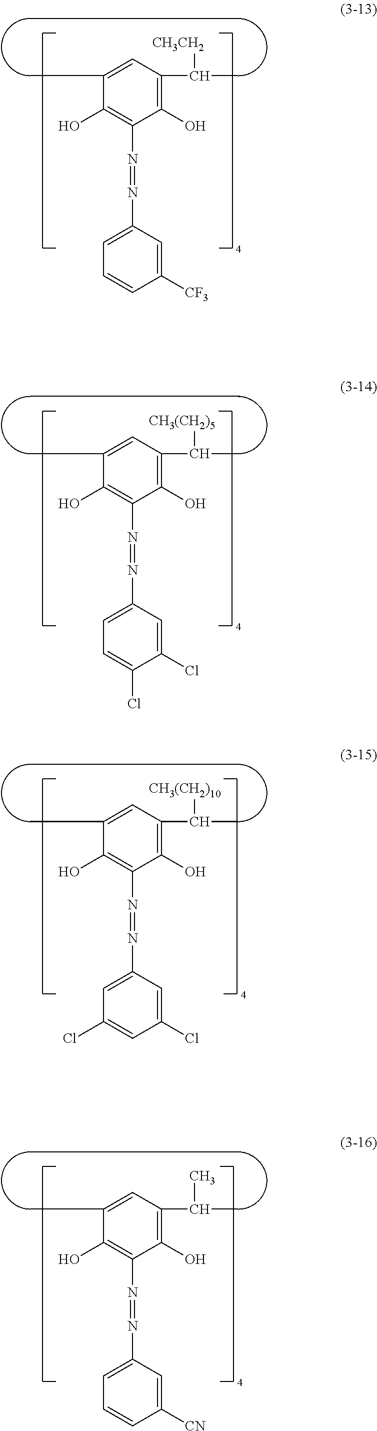

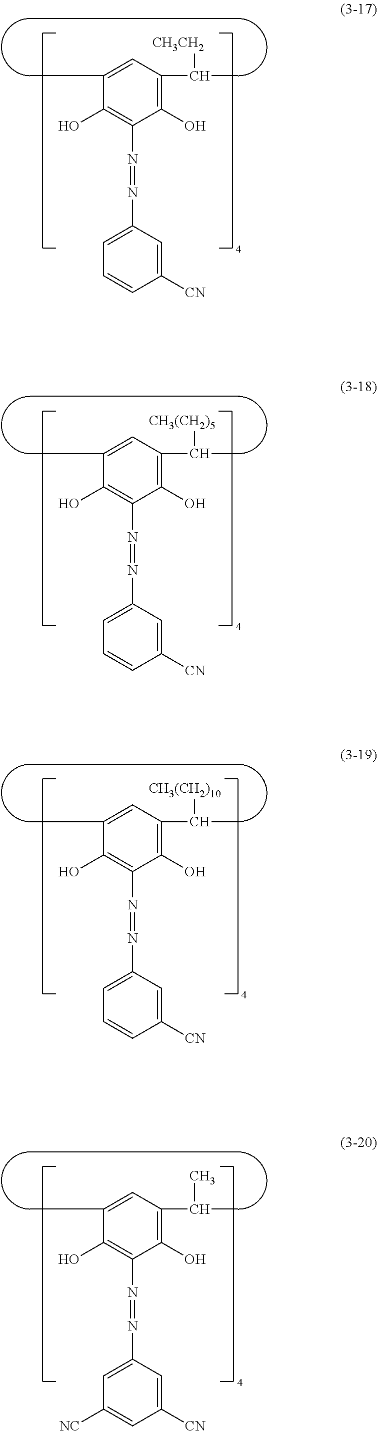

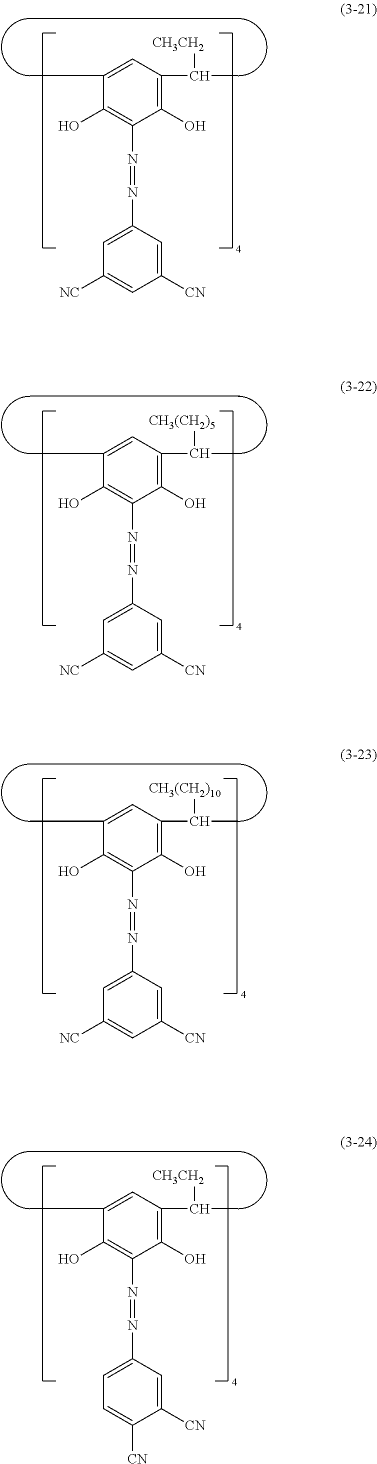

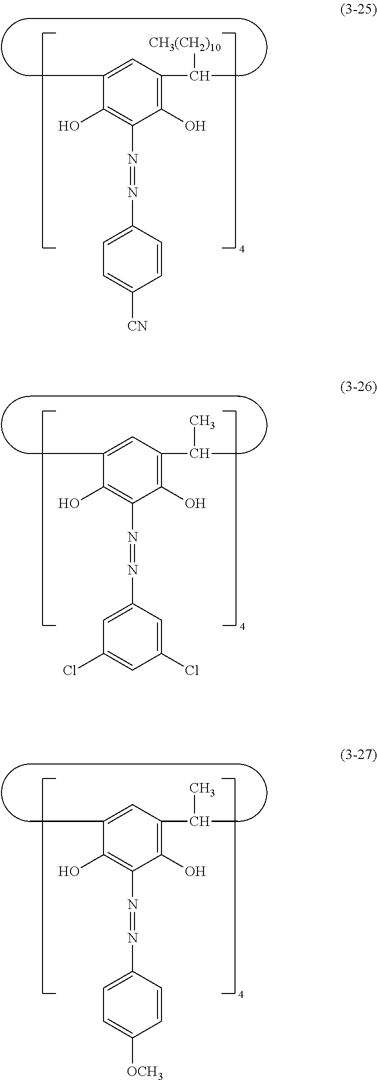

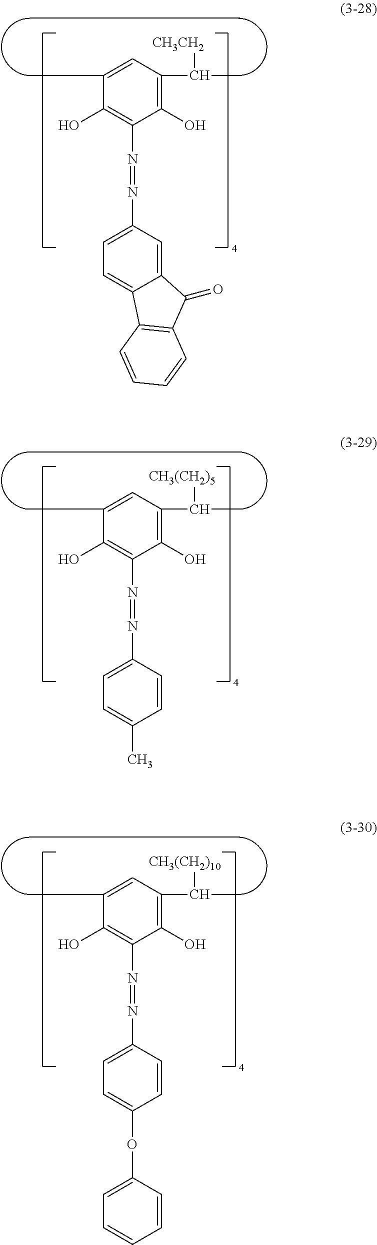

Examples of the gallium phthalocyanine crystal contained in a charge generating layer include those including a gallium phthalocyanine molecule in which a gallium atom has a halogen atom, a hydroxy group or an alkoxy group as an axial ligand. The phthalocyanine ring may have a substituent such as a halogen atom.

The gallium phthalocyanine crystal can be a gallium phthalocyanine crystal in which N,N-dimethylformamide is contained.

Among these gallium phthalocyanine crystals, hydroxygallium phthalocyanine crystals, bromogallium phthalocyanine crystals and iodogallium phthalocyanine crystals having high sensitivity are preferable because these effectively act in the present invention. Among these, hydroxygallium phthalocyanine crystals are more preferable. In the hydroxygallium phthalocyanine crystals, a gallium atom has a hydroxy group as an axial ligand. In the bromogallium phthalocyanine crystals, a gallium atom has a bromine atom as an axial ligand. In the iodogallium phthalocyanine crystals, a gallium atom has an iodine atom as an axial ligand.

Among these hydroxygallium phthalocyanine crystals, hydroxygallium phthalocyanine crystals having a crystal form having peaks at Bragg angles 2θ of 7.4°±0.3° and 28.2°±0.3° in X-ray diffraction with CuKa radiation are particularly preferable because images with high quality are attained.

The gallium phthalocyanine crystal containing the nitrogen-containing heterocyclic compound within the crystal means that the nitrogen-containing heterocyclic compound is incorporated into the crystal.

The method of preparing a gallium phthalocyanine crystal containing the nitrogen-containing heterocyclic compound within the crystal will be described.

The gallium phthalocyanine crystal containing the above nitrogen-containing heterocyclic compound within the crystal according to the present invention is prepared by mixing gallium phthalocyanine prepared by acid pasting and a nitrogen-containing heterocyclic compound with a solvent, and converting the mixture into crystals by wet milling.

The milling here is a treatment performed with a dispersant such as glass beads, steel beads and alumina balls in a milling apparatus such as a sand mill and a ball mill. The milling time can be approximately 10 to 60 hours. In a particularly preferable method, a sample is taken every 5 to 10 hours to examine the Bragg angle of the crystal. The amount of the dispersant to be used in milling can be 10 to 50 times that of gallium phthalocyanine in terms of mass. Examples of the solvent to be used include amide solvents such as N,N-dimethylformamide, N,N-dimethylacetamide, N-methylformamide, N-methylacetoamide and N-methylpropioamide; halogen-containing solvents such as chloroform; ether solvents such as tetrahydrofuran; and sulfoxide solvents such as dimethyl sulfoxide. The amount of the solvent to be used can be 5 to 30 times that of gallium phthalocyanine in terms of mass. The amount of the nitrogen-containing heterocyclic compound to be used can be 0.1 to 10 times that of gallium phthalocyanine in terms of mass.

The prepared gallium phthalocyanine crystal is measured by NMR and thermogravimetry (TG) to analyze the obtained data to thereby determine whether the gallium phthalocyanine crystal according to the present invention contains the nitrogen-containing heterocyclic compound within the crystal.

For example, when the nitrogen-containing heterocyclic compound is milled with a solvent that can dissolve the compound or when the nitrogen-containing heterocyclic compound is milled and washed with such a solvent, the prepared gallium phthalocyanine crystal is measured by NMR. Detection of the nitrogen-containing heterocyclic compound indicates that the nitrogen-containing heterocyclic compound is contained within the crystal.

In contrast, when the nitrogen-containing heterocyclic compound is insoluble in the solvent used for milling and also insoluble in a washing solvent used after milling, the prepared gallium phthalocyanine crystal is analyzed by NMR. If the nitrogen-containing heterocyclic compound is detected, the following method is used to determine whether the nitrogen-containing heterocyclic compound is contained within the crystal.

The gallium phthalocyanine crystal prepared by adding the nitrogen-containing heterocyclic compound, a gallium phthalocyanine crystal prepared similarly without adding the nitrogen-containing heterocyclic compound and the nitrogen-containing heterocyclic compound alone are individually analyzed by TG. When the result of TG analysis of the gallium phthalocyanine crystal prepared by adding the nitrogen-containing heterocyclic compound can be interpreted as a mixture of the result of TG analysis of the gallium phthalocyanine crystal prepared without adding the nitrogen-containing heterocyclic compound and that on the nitrogen-containing heterocyclic compound alone in a predetermined ratio, the result can be determined as follows. Namely, detection of the nitrogen-containing heterocyclic compound in this case indicates that a mixture of the gallium phthalocyanine crystal and the nitrogen-containing heterocyclic compound is generated, or the nitrogen-containing heterocyclic compound simply adheres to the surfaces of the gallium phthalocyanine crystals.

When the result of TG analysis of the gallium phthalocyanine crystal prepared by adding the nitrogen-containing heterocyclic compound exhibits a reduction in weight at a temperature higher than that in TG analysis of the nitrogen-containing heterocyclic compound alone, the result can be determined as follows. Namely, detection of the nitrogen-containing heterocyclic compound indicates that the nitrogen-containing heterocyclic compound is contained within the gallium phthalocyanine crystal.

The gallium phthalocyanine crystal contained in the electrophotographic photosensitive member according to the present invention is analyzed by TG, X-ray diffraction and

NMR under the following conditions.

[TG Analysis]

Analyzer to be used: manufactured by Seiko Instruments Inc., TG/DTA simultaneous analyzer (trade name: TG/DTA220U)

Atmosphere: under a nitrogen stream (300 m³/min)
Range for analysis: 35° C. to 600° C.
Temperature raising rate: 10° C./min

[Powder X-ray Diffraction Analysis]

Analyzer to be used: manufactured by Rigaku Corporation, X-ray diffraction apparatus RINT-TTRII

X-ray tube: Cu
Tube voltage: 50 KV
Tube current: 300 mA
Scanning method: 2θ/θ scan
Scanning rate: 4.0°/min
Sampling interval: 0.02°
Start angle (2θ): 5.0°
Stop angle (2θ): 40.0°
Attachment: standard sample holder
Filter: not used
Incident monochromator: used
Counter monochromator: not used
Divergence slit: opened
Vertical divergence limiting slit: 10.00 mm
Scattering slit: opened
Receiving slit: opened
Flat plate monochromator: used
Counter: scintillation counter

### [NMR Analysis]

Analyzer to be used: manufactured by BRUKER Corporation, AVANCEIII 500
Solvent: sodium bisulfate (D₂SO₄)

The photosensitive layer on a support of the electrophotographic photosensitive member according to the present invention is a laminate photosensitive layer including a charge generating layer and a charge transporting layer disposed thereon. The charge generating layer is as described above, and the charge transporting layer contains a charge transport substance.

The support used in the present invention may have conductivity (may be a conductive support). Examples of the material for the support include metals such as aluminum and stainless steel and alloys thereof, and metals, alloys, plastics and papers having a conductive layer. Examples of shapes of the support include cylindrical shapes and film-like shapes.

In the present invention, an undercoat layer having barrier function and bonding function (also referred to as an intermediate layer) can be disposed between the support and the photosensitive layer.

Examples of the material for the undercoat layer to be used include polyvinyl alcohol, polyethylene oxide, ethyl cellulose, methyl cellulose, casein, polyamide, glue and gelatin. These are dissolved in a proper solvent to be applied onto the support.

The undercoat layer can have a thickness of 0.3 to 5.0 μm.

A conductive layer is suitably disposed between the support and the undercoat layer to cover unevenness and defects of the support and prevent interference fringes.

The conductive layer can be formed by dispersing carbon black, metal particles and conductive particles of e.g. metal oxides in a binder resin.

The conductive layer has a thickness of preferably 5 to 40 μm, particularly preferably 10 to 30 μm.

In disposition of the charge generating layer, the nitrogen-containing heterocyclic compound, a gallium phthalocyanine crystal or a gallium phthalocyanine crystal in which a nitrogen-containing heterocyclic compound is contained, and the compound represented by Formula (1) or Formula (2), a binder resin, and a solvent are mixed to prepare a coating solution for a charge generating layer. The coating solution for a charge generating layer is applied to form a coating. The coating is dried.

The dispersion can be performed with a dispersing machine such as medium type dispersing machines (e.g., sand mills and ball mills) or a solution collision type dispersing machine.

The charge generating layer has a thickness of preferably 0.05 to 1 μm, more preferably 0.1 to 0.3 μm.

The content of the nitrogen-containing heterocyclic compound in the charge generating layer is preferably 0.01% by mass or more and 20% by mass or less, more preferably 0.1% by mass or more and 5% by mass or less based on the gallium phthalocyanine crystal. The nitrogen-containing heterocyclic compound contained in the charge generating layer may be amorphous or crystalline. These nitrogen-containing heterocyclic compounds may be used in combinations of two or more. The gallium phthalocyanine crystal containing the nitrogen-containing heterocyclic compound within the crystal in the charge generating layer can contain 0.01% by mass or more and 20% by mass or less nitrogen-containing heterocyclic compound based on the gallium phthalocyanine crystal. The content of the nitrogen-containing heterocyclic compound is more preferably 0.1% by mass or more and 5% by mass or less.

The content of the compound represented by Formula (1) or (2) in the charge generating layer can be 0.3% by mass or more and 5% by mass or less based on the gallium phthalocyanine crystal.

The content of the gallium phthalocyanine crystal in the charge generating layer is preferably 30% by mass or more and 90% by mass or less, more preferably 50% by mass or more and 80% by mass or less based on the total mass of the charge generating layer.

The compound represented by Formula (1) or (2) contained in the charge generating layer may be amorphous or crystalline. These compounds represented by Formula (1) or (2) may be used in combinations of two or more.

Examples of the binder resin for the charge generating layer include polyester resins, acrylic resins, phenoxy resins, polycarbonate resins, polyvinyl butyral resins, polystyrene resins, polyvinyl acetate resins, polysulfone resins, polyarylate resins, vinylidene chloride resins, acrylonitrile copolymers, and polyvinyl benzal resins. Among these, preferable resins for dispersing the nitrogen-containing heterocyclic compound are polyvinyl butyral resins and polyvinyl benzal resins.

The charge transporting layer can be disposed as follows: mainly a charge transport substance and a binder resin are dissolved in a solvent to prepare a coating solution for a charge transporting layer. The coating is dried.

The charge transporting layer has a thickness of preferably 5 to 40 μm, particularly preferably 10 to 25 μm.

The content of the charge transport substance is preferably 20 to 80% by mass, particularly preferably 30 to 60% by mass based on the total mass of the charge transporting layer.

Examples of the charge transport substance include a variety of triarylamine compounds, hydrazone compounds, stilbene compounds, pyrazoline compounds, oxazole compounds, thiazole compounds and triallylmethane compounds. Among these, preferable charge transport substances are triarylamine compounds.

Examples of the binder resin used for the charge transporting layer include resins such as polyester resins, acrylic resins, phenoxy resins, polycarbonate resins, polystyrene resins, polyvinyl acetate resins, polysulfone resins, polyarylate resins, vinylidene chloride resins and acrylonitrile copolymers. Among these, polycarbonate resins and polyarylate resins are preferable.

For the methods of applying the respective layers, coating methods such as immersion coating (dipping), spray coating, spinner coating, bead coating, blade coating and beam coating can be used.

A protective layer may be disposed on the photosensitive layer to protect the photosensitive layer.

The protective layer can be disposed as follows: a resin is dissolved in a proper organic solvent to prepare a coating solution for a protective layer. The coating solution is applied onto the photosensitive layer, and is dried. Examples of the resin used for the protective layer include polyvinyl butyral resins, polyester resins, polycarbonate resins (such as polycarbonate Z resins and modified polycarbonate resins), nylon resins, polyimide resins, polyarylate resins, polyurethane resins, styrene-butadiene copolymers, styrene-acrylic acid copolymers and styrene-acrylonitrile copolymers. The protective layer can also be disposed by applying the coating solution for a protective layer onto the photosensitive layer, and curing the coating solution by heating, an electron beam, ultraviolet light or the like. The protective layer can have a thickness of preferably 0.05 to 20 μm.

The protective layer may contain conductive particles, an ultraviolet absorbing agent and lubricating particles such as resin fine particles containing a fluorine atom. Preferable examples of the conductive particles include metal oxide particles such as tin oxide particles.

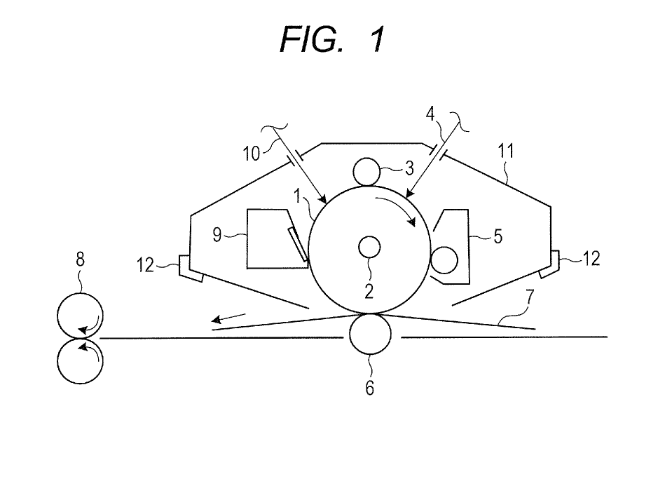

FIG. 1 is a drawing illustrating an example of a schematic configuration of an electrophotographic apparatus including the process cartridge including an electrophotographic photosensitive member according to the present invention.

A cylindrical (drum-shaped) electrophotographic photosensitive member 1 is rotated about an axis 2 in the arrow direction at a predetermined circumferential speed (process speed) for driving.

The surface of the electrophotographic photosensitive member 1 is charged positively or negatively at a predetermined potential by a charging unit 3 while the electrophotographic photosensitive member 1 is being rotated. The charged surface of the electrophotographic photosensitive member 1 is irradiated with image exposing light 4 from an image exposing unit (not illustrated) to form an electrostatic latent image corresponding to the information on the target image. The image exposing light is the light whose intensity is modulated in correspondence with the time-series electric digital image signals indicating the information on the target image, which are output from an image exposing unit through slit exposure, exposure by laser beam scanning or the like.

The electrostatic latent image formed on the surface of the electrophotographic photosensitive member 1 is developed (normal development or reversal development) with a toner accommodated in a developing unit 5 to form a toner image on the surface of the electrophotographic photosensitive member 1. The toner image formed on the surface of the electrophotographic photosensitive member 1 is transferred onto a transfer material 7 by a transferring unit 6. At this time, a bias voltage having a polarity opposite to that of the toner charged is applied to the transferring unit 6 from a bias power supply (not illustrated). When the transfer material 7 is paper, the transfer material 7 is taken out from a paper feeding unit (not illustrated) and fed between the electrophotographic photosensitive member 1 and the transferring unit 6 in synchronization with rotation of the electrophotographic photosensitive member 1.

The transfer material 7 having the toner image transferred from the electrophotographic photosensitive member 1 is separated from the surface of the electrophotographic photosensitive member 1, and is fed to an image fixing unit 8 to fix the toner image. The transfer material 7 is thereby printed out to the outside of the electrophotographic apparatus as an image-formed product (print, copy).

After the toner image is transferred onto the transfer material 7, the surface of the electrophotographic photosensitive member 1 is cleaned by removing adherents such as the toner (transfer remaining toner) by a cleaning unit 9. The transfer remaining toner can be also directly removed by the developing unit or the like in a cleaner-less system developed in these days. The surface of the electrophotographic photosensitive member 1 is discharged with pre-exposing light 10 from a pre-exposing unit (not illustrated), and is repeatedly used for image formation. When the charging unit 3 is a contact charging unit including a charging roller, the pre-exposing unit is not always necessary.

In the present invention, a process cartridge is prepared by integrally supporting several components among the electrophotographic photosensitive member 1, the charging unit 3, the developing unit 5, the transferring unit 6 and the cleaning unit 9 which are put in a case. The process cartridge can be configured to be detachably mountable on the main body of the electrophotographic apparatus. For example, at least one selected from the group consisting of the charging unit 3, the developing unit 5, the transferring unit 6 and the cleaning unit 9 is supported integrally with the electrophotographic photosensitive member 1 to form a cartridge. Then, the process cartridge 11 can be detachably mounted on the main body of the electrophotographic apparatus with a guiding unit 12 such as a rail provided in the main body of the electrophotographic apparatus.

The image exposing light 4 may be light reflected from or transmitted through an original manuscript when the electrophotographic apparatus is a copier or a printer. Alternatively, the image exposing light 4 may be the light emitted by, for example, scanning with a laser beam or driving of an LED array or a liquid crystal shutter array according to the signals obtained by reading the manuscript with a sensor.

The electrophotographic photosensitive member 1 according to the present invention can be widely used in application fields of electrophotography such as laser beam printers, CRT printers, LED printers, FAX machines, liquid crystal printers and laser plate making.

### EXAMPLES

Now, the present invention will be described more in detail using specific Examples. The unit “parts” means “parts by mass” below. The present invention will not be limited to these. The thicknesses of the respective layers included in the electrophotographic photosensitive members in Examples and Comparative Examples were determined by a method using an eddy current coating thickness measuring apparatus (Fischerscope, manufactured by Helmut Fischer GmbH) or a method of calculating a specific gravity from the mass per unit area.

### Synthesis Example 1

Under an atmosphere with a nitrogen stream, phthalonitrile (5.46 parts) and α-chloronaphthalene (45 parts) were placed in a reaction vessel, were heated to a temperature of 30° C., and were kept at this temperature. Next, at this temperature (30° C.), gallium trichloride (3.75 parts) was added. At this time, the moisture content of the mixed solution was 150 ppm. Subsequently, the temperature was raised to 200° C. Next, under an atmosphere with a nitrogen stream, the reaction was made at a temperature of 200° C. for 4.5 hours. The reaction product was cooled, and was filtered when the temperature reached 150° C. The filtered product thus obtained was dispersed and washed with N,N-dimethylformamide at a temperature of 140° C. for 2 hours, and was filtered. The filtered product thus obtained was washed with methanol, and was dried to prepare a chlorogallium phthalocyanine pigment (4.65 parts, yield: 71%).

Next, the chlorogallium phthalocyanine pigment (4.65 parts) thus obtained was dissolved in concentrated sulfuric acid (139.5 parts) at a temperature of 10° C., and was dropped into ice water (620 parts) under stirring to be reprecipitated. The resultant product was filtered through a filter press. The wet cake (filtered product) thus obtained was dispersed and washed with 2% aqueous ammonia, and was filtered through a filter press. Subsequently, the wet cake (filtered product) thus obtained was then dispersed and washed with ion exchange water, and was filtered through a filter press. This operation was repeated 3 times to prepare a hydroxygallium phthalocyanine pigment (solid content; 23%) (hydrated hydroxygallium phthalocyanine pigment).

### Synthesis Example 2

Under an atmosphere with a nitrogen stream, phthalonitrile (5.46 parts) and α-chloronaphthalene (45 parts) were placed in a reaction vessel, were heated to a temperature of 30° C., and were kept at this temperature. Next, at this temperature (30° C.), gallium trichloride (3.75 parts) was added. At this time, the moisture content of the mixed solution was 150 ppm. Subsequently, the temperature was raised to 200° C. Next, under an atmosphere with a nitrogen stream, the reaction was made at a temperature of 200° C. for 4.5 hours. The reaction product was cooled, and was filtered when the temperature reached 150° C. The filtered product thus obtained was dispersed and washed with N,N-dimethylformamide at a temperature of 140° C. for 2 hours, and was filtered. The filtered product thus obtained was washed with methanol, and was dried to prepare a chlorogallium phthalocyanine pigment (4.65 parts, yield: 71%).

### Example 1-1

The hydroxygallium phthalocyanine pigment prepared in Synthesis Example 1 (hydrated hydroxygallium phthalocyanine pigment, 6.6 kg) was dried with a hyper-dry dryer (trade name: HD-06R, frequency (oscillating frequency): 2455 MHz±15 MHz, manufactured by Biocon (Japan) Ltd.) as follows.

The hydroxygallium phthalocyanine pigment prepared in Synthesis Example 1 was placed on a dedicated circular plastic tray as a bulk extracted from the filter press (thickness of the hydrated cake: 4 cm or less). Far infrared rays were set to be OFF, and the temperature of the inner wall of the dryer was set to be 50° C. A vacuum pump and a leak valve were adjusted during irradiation with microwaves, and a degree of vacuum was adjusted to be 4.0 to 10.0 kPa.

First, in a first step, the hydroxygallium phthalocyanine pigment was irradiated with a microwave of 4.8 kW for 50 minutes. Next, the microwave was turned off, and the leak valve was closed to provide a high vacuum atmosphere at 2 kPa or less. At this time, the solid content of the hydroxygallium phthalocyanine pigment was 88%.

In a second step, the leak valve was adjusted to control the degree of vacuum (inner pressure of the dryer) to fall within the setting value (4.0 to 10.0 kPa). The hydroxygallium phthalocyanine pigment was irradiated with a microwave of 1.2 kW for 5 minutes. The microwave was turned off again, and the leak valve was closed to provide a high vacuum atmosphere at 2 kPa or less. The second step was repeated one more time (twice in total). At this time, the solid content of the hydroxygallium phthalocyanine pigment was 98%.

In a third step, the hydroxygallium phthalocyanine pigment was irradiated with a microwave in the same manner as in irradiation with a microwave in the second step except that the output of the microwave in the second step was changed from 1.2 kW to 0.8 kW. The third step was repeated one more time (twice in total).

In a fourth step, the leak valve was adjusted to return the degree of vacuum (inner pressure of the dryer) to a value within the setting range of pressure (4.0 to 10.0 kPa). The hydroxygallium phthalocyanine pigment was irradiated with a microwave of 0.4 kW for 3 minutes. The microwave was turned off, and the leak valve was closed to provide a high vacuum atmosphere at 2 kPa or less. The fourth step was repeated 7 times (8 times in total).

A hydroxygallium phthalocyanine crystal (pigment) having a hydration rate of 1% or less (1.52 kg) was thus prepared in 3 hours in total.

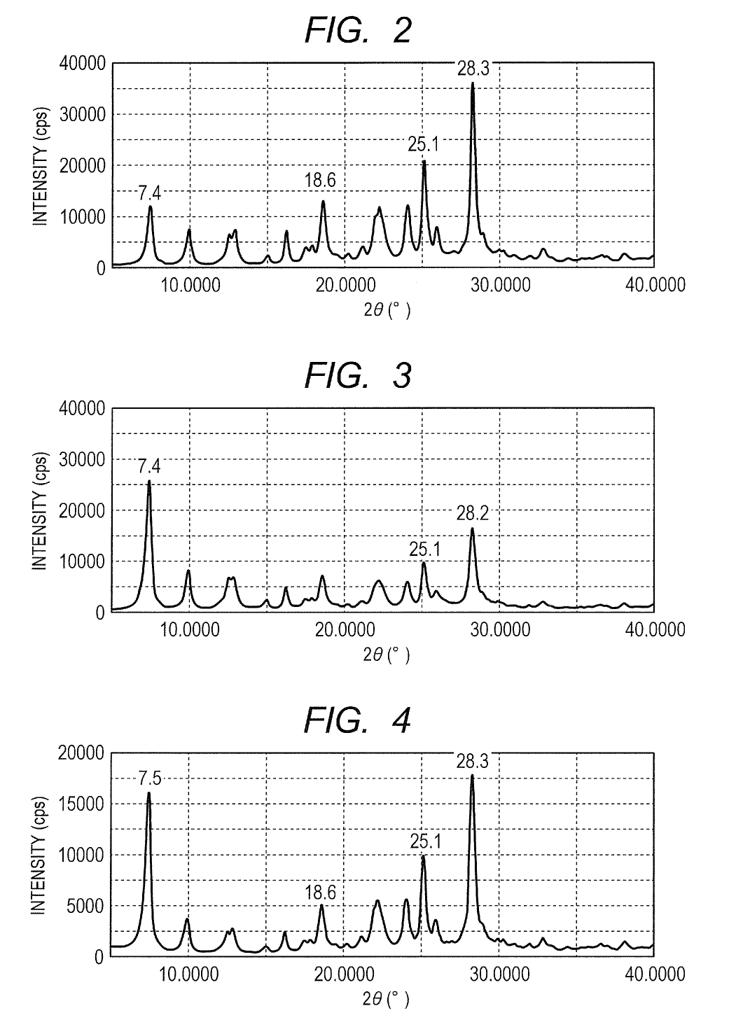

Next, the hydroxygallium phthalocyanine crystal (0.5 parts) thus obtained, Exemplary compound (7) (production code: P0196, manufactured by Tokyo Chemical Industry Co., Ltd., 2.0 parts), and N,N-dimethylformamide (9.5 parts) were milled with glass beads (15 parts, diameter: 0.8 mm) at room temperature (23° C.) for 45 hours in a ball mill. The gallium phthalocyanine crystal was extracted from the dispersion liquid with N,N-dimethylformamide, and was filtered. The gallium phthalocyanine crystal on the filter was sufficiently washed with tetrahydrofuran. The filtered product was vacuum dried to prepare a hydroxygallium phthalocyanine crystal (0.45 parts). The result of powder X-ray diffraction of the resulting crystal is shown in FIG. 2.

NMR analysis indicated that the hydroxygallium phthalocyanine crystal thus obtained contains 0.54% by mass Exemplary compound (7) and 2.13% by mass N,N-dimethylformamide in terms of the ratio of proton. Exemplary compound (7) is soluble in N,N-dimethylformamide. Accordingly, this indicates that Exemplary compound (7) is contained within the crystal.

### Example 1-2

A hydroxygallium phthalocyanine crystal in Example 1-2 was prepared in the same manner as in Example 1-1 except that Exemplary compound (7) used in Example 1-1 (2.0 parts) was not used. The result of powder X-ray diffraction of the resulting crystal is shown in FIG. 3.

### Example 1-3

The amount of Exemplary compound (7) used in Example 1-1 (2.0 parts) was changed to 1.0 part. Instead of milling with a ball mill for 45 hours, milling was performed with a paint shaker (manufactured by Toyo Seiki Seisaku-sho, Ltd.) for 21 hours. Except these, a hydroxygallium phthalocyanine crystal in Example 1-3 was prepared in the same manner as in Example 1-1. The result of powder X-ray diffraction of the resulting crystal is similar to that shown in FIG. 2.

Similarly to Example 1-1, NMR analysis indicated that the hydroxygallium phthalocyanine crystal contains 0.19% by mass Exemplary compound (7) and 2.28% by mass N,N-dimethylformamide.

### Example 1-4

A hydroxy gallium phthalocyanine pigment having a water content of 1% or less (1.52 kg) was prepared in the same manner as in Example 1-1.

Next, the hydroxy gallium phthalocyanine crystal (0.5 parts), Exemplary compound (7) (0.5 parts), Exemplary compound (2-1) (0.05 parts), and N,N-dimethylformamide (9.5 parts) were milled with glass beads (15 parts) having a diameter of 0.8 mm in a ball mill under room temperature (23° C.) for 48 hours. The gallium phthalocyanine crystal was extracted with N,N-dimethylformamide from the dispersion liquid, and was filtered. The gallium phthalocyanine crystal on the filter was sufficiently washed with tetrahydrofuran. The filtered product was vacuum dried to prepare a hydroxy gallium phthalocyanine crystal (0.45 parts). The result of powder X ray diffraction of the resulting crystal is similar to that shown in FIG. 2.

Similarly to Example 1-1, NMR analysis indicated that the hydroxy gallium phthalocyanine crystal contains 0.15% by mass Exemplary compound (7), 0.05% by mass Exemplary compound (2-1) and 2.13% by mass N,N-dimethylformamide.

### Example 1-5

A hydroxygallium phthalocyanine crystal in Example 1-5 was prepared in the same manner as in Example 1-1 except that Exemplary compound (7) used in Example 1-1 (2.0 parts) was replaced by Exemplary compound (16) (production code: T2215, manufactured by Tokyo Chemical Industry Co., Ltd.) (1.0 part). The result of powder X-ray diffraction of the resulting crystal is similar to that shown in FIG. 2.

Similarly to Example 1-1, NMR analysis indicated that the hydroxygallium phthalocyanine crystal contains 0.70% by mass Exemplary compound (16) and 2.04% by mass N,N-dimethylformamide.

### Example 1-6

A hydroxygallium phthalocyanine crystal in Example 1-6 was prepared in the same manner as in Example 1-1 except that Exemplary compound (7) used in Example 1-1 (2.0 parts) was replaced by Exemplary compound (9) (production code: P1646, manufactured by Tokyo Chemical Industry Co., Ltd.) (1.0 part). The result of powder X-ray diffraction of the resulting crystal is shown in FIG. 4.

Similarly to Example 1-1, NMR analysis indicated that the hydroxygallium phthalocyanine crystal contains 1.67% by mass Exemplary compound (9) and 1.79% by mass N,N-dimethylformamide.

### Example 1-7

Exemplary compound (7) (2.0 parts) used in Example 1-1 was replaced by Exemplary compound (2-25) (0.5 parts) and the milling time in the ball mill was changed from 45 hours to 42 hours. Except these, a hydroxy gallium phthalocyanine crystal in Example 1-7 was prepared in the same manner as in Example 1-1. The result of powder X ray diffraction of the resulting crystal is similar to that shown in FIG. 3.

Similarly to Example 1-1, NMR analysis indicated that the hydroxy gallium phthalocyanine crystal contains 1.09% by mass Exemplary compound (2-25) and 2.60% by mass N,N-dimethylformamide.

### Example 1-8

Exemplary compound (2-25) (0.5 parts) used in Example 1-7 was replaced by Exemplary compound (2-1) (0.05 parts) and N,N-dimethylformamide was replaced by dimethyl sulfoxide. Except these, a hydroxy gallium phthalocyanine crystal in Example 1-8 was prepared in the same manner as in Example 1-7. The result of powder X ray diffraction of the resulting crystal is similar to that shown in FIG. 3.

Similarly to Example 1-1, NMR analysis indicated that the hydroxy gallium phthalocyanine crystal contains 0.05% by mass Exemplary compound (2-1) and 2.18% by mass dimethyl sulfoxide.

### Example 1-9

Exemplary compound (2-25) (0.5 parts) used in Example 1-7 was replaced by Exemplary compound (2-1) (0.05 parts). Except this, a hydroxy gallium phthalocyanine crystal in Example 1-9 was prepared in the same manner as in Example 1-7. The result of powder X ray diffraction of the resulting crystal is similar to that shown in FIG. 2.

Similarly to Example 1-1, NMR analysis indicated that the hydroxy gallium phthalocyanine crystal contains 0.15% by mass Exemplary compound (2-1) and 2.00% by mass N,N-dimethylformamide.

### Example 1-10

A hydroxy gallium phthalocyanine crystal in Example 1-10 was prepared in the same manner as in Example 1-7 except that the amount of Exemplary compound (2-25) (0.5 parts) used in Example 1-7 was changed to 0.05 parts. The result of powder X ray diffraction of the resulting crystal is similar to that shown in FIG. 2.

Similarly to Example 1-1, NMR analysis indicated that the hydroxy gallium phthalocyanine crystal contains 0.34% by mass Exemplary compound (2-25) and 2.21% by mass N,N-dimethylformamide.

### Example 1-11

Exemplary compound (7) used in Example 1-1 (2.0 parts) was replaced by Exemplary compound (66) (1.0 part). The milling time with a ball mill was changed from 45 hours to 50 hours. Except these, a hydroxygallium phthalocyanine crystal in Example 1-11 was prepared in the same manner as in Example 1-1. The result of powder X-ray diffraction of the resulting crystal is similar to that shown in FIG. 2.

Similarly to Example 1-1, NMR analysis indicated that the hydroxygallium phthalocyanine crystal contains 0.06% by mass Exemplary compound (66) and 1.93% by mass N,N-dimethylformamide.

### Example 1-12

A hydroxy gallium phthalocyanine crystal in Example 1-12 was prepared in the same manner as in Example 1-7 except that Exemplary compound (2-25) (0.5 parts) used in Example 1-7 was replaced by Exemplary compound (3-1) (0.05 parts). The result of powder X ray diffraction of the resulting crystal is similar to that shown in FIG. 2.

Similarly to Example 1-1, NMR analysis indicated that the hydroxy gallium phthalocyanine crystal contains 1.72% by mass Exemplary compound (3-1) and 2.32% by mass N,N-dimethylformamide.

### Example 1-13

A hydroxygallium phthalocyanine crystal in Example 1-13 was prepared in the same manner as in Example 1-1 except that Exemplary compound (7) used in Example 1-1 (2.0 parts) was replaced by Exemplary compound (10) (production code: F0157, manufactured by Tokyo Chemical Industry Co., Ltd.) (1.0 part). The result of powder X-ray diffraction of the resulting crystal is similar to that shown in FIG. 2.

Similarly to Example 1-1, NMR analysis indicated that the hydroxygallium phthalocyanine crystal contains 0.22% by mass Exemplary compound (10) and 2.34% by mass N,N-dimethylformamide.

### Example 1-14

A hydroxygallium phthalocyanine crystal in Example 1-14 was prepared in the same manner as in Example 1-1 except that Exemplary compound (7) used in Example 1-1 (2.0 parts) was replaced by Exemplary compound (1) (production code: M0370, manufactured by Tokyo Chemical Industry Co., Ltd.) (0.5 parts). The result of powder X-ray diffraction of the resulting crystal is similar to that shown in FIG. 2.

Similarly to Example 1-1, NMR analysis indicated that the hydroxygallium phthalocyanine crystal contains 0.38% by mass Exemplary compound (1) and 2.04% by mass N,N-dimethylformamide.

### Example 1-15

A hydroxygallium phthalocyanine crystal in Example 1-15 was prepared in the same manner as in Example 1-14 except that the amount of Exemplary compound (1) used in Example 1-14 (0.5 parts) was changed to 2.0 parts and N,N-dimethylformamide was replaced by dimethyl sulfoxide. The result of powder X-ray diffraction of the resulting crystal is similar to that shown in FIG. 2.

Similarly to Example 1-1, NMR analysis indicated that the hydroxygallium phthalocyanine crystal contains 1.29% by mass Exemplary compound (1) and 2.30% by mass dimethyl sulfoxide.

### Example 1-16

A hydroxygallium phthalocyanine crystal in Example 1-16 was prepared in the same manner as in Example 1-1 except that Exemplary compound (7) used in Example 1-1 (2.0 parts) was replaced by Exemplary compound (2) (production code: E0145, manufactured by Tokyo Chemical Industry Co., Ltd.) (1.0 part). The result of powder X-ray diffraction of the resulting crystal is similar to that shown in FIG. 2.

Similarly to Example 1-1, NMR analysis indicated that the hydroxygallium phthalocyanine crystal contains 0.63% by mass Exemplary compound (2) and 2.13% by mass N,N-dimethylformamide.

### Comparative Example 1-1

The Formula (7) used in Example 1-1 (2.0 parts) was replaced by a nitrogen-containing heterocyclic compound represented by the following Formula (8) (production code: M0465, manufactured by Tokyo Chemical Industry Co., Ltd.) (1.0 part):

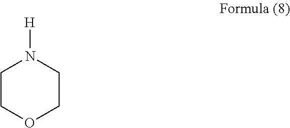

Except that, a hydroxygallium phthalocyanine crystal in Comparative Example 1-1 was prepared in the same manner as in Example 1-1. The result of powder X-ray diffraction of the resulting crystal is similar to that shown in FIG. 3.

Similarly to Example 1-1, NMR analysis indicated that the hydroxygallium phthalocyanine crystal contains 0.55% by mass nitrogen-containing heterocyclic compound represented by Formula (8) and 2.03% by mass N,N-dimethylformamide.

### Example 2-1

An aluminum cylinder having a diameter of 24 mm and a length of 257 mm was used as a support (cylindrical support).

Next, a barium sulfate particle coated with tin oxide (trade name: Passtran PC1, manufactured by Mitsui Mining & Smelting Co., Ltd.) (60 parts), a titanium oxide particle (trade name: TITANIX JR, manufactured by Tayca Corporation) (15 parts), a resol phenol resin (trade name: PHENOLITE J-325, manufactured by DIC Corporation, solid content: 70% by mass) (43 parts), silicone oil (trade name: SH28 PA, manufactured by Dow Corning Toray Silicone Co., Ltd.) (0.015 parts), a silicone resin particle (trade name: Tospearl 120, manufactured by Dow Corning Toray Co., Ltd.) (3.6 parts), 2-methoxy-1-propanol (50 parts) and methanol (50 parts) were placed in a ball mill, and were dispersed for 20 hours to prepare a coating solution for a conductive layer. The coating solution for a conductive layer was applied onto the support by immersion coating to form a coating. The coating was heated at 140° C. for 1 hour to be cured. A conductive layer having a thickness of 20 μm was thereby disposed.

Next, N-methoxymethylated nylon 6 (trade name: TORESIN EF-30T, manufactured by Nagase ChemteX Corporation) (25 parts) was dissolved (dissolved by heating at 65° C.) in a mixed solution of methanol/n-butanol=2/1 (480 parts), and the resultant solution was cooled. Subsequently, the solution was filtered through a membrane filter (trade name: FP-022, pore diameter: 0.22 μm, manufactured by Sumitomo Electric Industries, Ltd.) to prepare a coating solution for an undercoat layer. The coating solution for an undercoat layer thus prepared was applied onto the conductive layer by immersion to form a coating. The coating was dried by heating with an oven at a temperature of 100° C. for 10 minutes to dispose an undercoat layer having a thickness of 0.45 μm.

Next, the hydroxygallium phthalocyanine crystal prepared in Example 1-1 (charge generating substance) (20 parts) Exemplary compound (2-1) (0.2 parts), polyvinyl butyral (trade name: S-LEC BX-1, manufactured by Sekisui Chemical Co., Ltd.) (10 parts), and cyclohexanone (519 parts) were placed in a sand mill containing glass beads having a diameter of 1 mm, and were dispersed for 4 hours. Subsequently, ethyl acetate (764 parts) was added to prepare a coating solution for a charge generating layer. The coating solution for a charge generating layer was applied onto the undercoat layer by immersion coating to form a coating. The coating was dried at 100° C. for 10 minutes to dispose a charge generating layer having a thickness of 0.18 μm.

Next, a triarylamine compound represented by Formula (9) (hole transport substance) (70 parts):

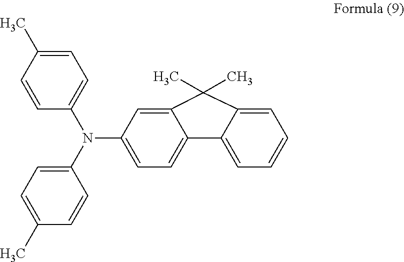 [SMILES: Cc1ccc(N(c2ccc(C)cc2)c2ccc3c(c2)C(C)(C)c2ccccc2-3)cc1]

a triarylamine compound represented by Formula (10) (hole transport substance) (10 parts):

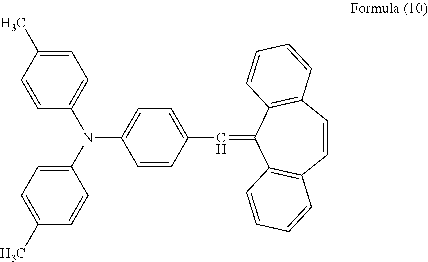 [SMILES: Cc1ccc(N(c2ccc(C)cc2)c2ccc(C=C3c4ccccc4C=Cc4ccccc43)cc2)cc1]

and polycarbonate (trade name: Iupilon Z-200, manufactured by Mitsubishi Engineering-Plastics Corporation) (100 parts) were dissolved in monochlorobenzene (630 parts) to prepare a coating solution for a charge transporting layer. The coating solution for a charge transporting layer was applied onto the charge generating layer by immersion coating to form a coating. The coating was dried at 120° C. for 1 hour to dispose a charge transporting layer (hole-transporting layer) having a thickness of 19 μm.

The coatings of the conductive layer, the undercoat layer, the charge generating layer and the charge transporting layer were subjected to heat treatment with an oven set to the respective temperatures. The same procedure is used in the following examples.

The cylindrical (drum-shaped) electrophotographic photosensitive member in Example 2-1 was prepared as above.

### Example 2-2

An electrophotographic photosensitive member in Example 2-2 was prepared in the same manner as in Example 2-1 except that preparation of the coating solution for a charge generating layer in Example 2-1 was changed as follows.

The hydroxygallium phthalocyanine crystal prepared in Example 1-2 (charge generating substance) (20 parts), Exemplary compound (7) (0.001 parts), Exemplary compound (2-1) (0.2 parts), polyvinyl butyral (trade name: S-LEC BX-1, manufactured by Sekisui Chemical Co., Ltd.) (10 parts), and cyclohexanone (519 parts) were placed in a sand mill containing glass beads having a diameter of 1 mm, and were dispersed for 4 hours. Subsequently, ethyl acetate (764 parts) was added to prepare a coating solution for a charge generating layer. The coating solution for a charge generating layer was applied onto the undercoat layer by immersion coating to form a coating. The coating was dried at 100° C. for 10 minutes to dispose a charge generating layer having a thickness of 0.18 μm.

### Example 2-3

An electrophotographic photosensitive member in Example 2-3 was prepared in the same manner as in Example 2-2 except that the amount of Exemplary compound (7) (0.001 parts) used in preparation of the coating solution for a charge generating layer in Example 2-2 was changed to 0.004 parts.

### Example 2-4

The hydroxygallium phthalocyanine crystal prepared in Example 1-1 (charge generating substance) (20 parts) used in preparation of the coating solution for a charge generating layer in Example 2-1 was replaced by the hydroxygallium phthalocyanine crystal prepared in Example 1-3 (charge generating substance) (20 parts). Except that, an electrophotographic photosensitive member in Example 2-4 was prepared in the same manner as in Example 2-1.

### Example 2-5

An electrophotographic photosensitive member in Example 2-5 was prepared in the same manner as in Example 2-1 except that preparation of the coating solution for a charge generating layer in Example 2-1 was changed as follows.

The hydroxy gallium phthalocyanine crystal (charge generating substance) prepared in Example 1-4 (20 parts), polyvinyl butyral (trade name: S-LEC BX-1, manufactured by Sekisui Chemical Co., Ltd.) (10 parts), and cyclohexanone (519 parts) were placed in a sand mill containing glass beads having a diameter of 1 mm, and were dispersed for 4 hours. Subsequently, ethyl acetate (764 parts) was added to prepare a coating solution for a charge generating layer. The coating solution for a charge generating layer was applied onto the undercoat layer by immersion coating to form a coating. The coating was dried at 100° C. for 10 minutes to dispose a charge generating layer having a thickness of 0.18 μm.

### Example 2-6

An electrophotographic photosensitive member in Example 2-6 was prepared in the same manner as in Example 2-1 except that preparation of the coating solution for a charge generating layer in Example 2-1 was changed as follows.

The hydroxygallium phthalocyanine crystal prepared in Example 1-1 (charge generating substance) (20 parts), Exemplary compound (7) (0.89 parts), Exemplary compound (2-1) (0.2 parts), polyvinyl butyral (trade name: S-LEC BX-1, manufactured by Sekisui Chemical Co., Ltd.) (10 parts), and cyclohexanone (519 parts) were placed in a sand mill containing glass beads having a diameter of 1 mm, and were dispersed for 4 hours. Subsequently, ethyl acetate (764 parts) was added to prepare a coating solution for a charge generating layer. The coating solution for a charge generating layer was applied onto the undercoat layer by immersion coating to form a coating. The coating was dried at 100° C. for 10 minutes to dispose a charge generating layer having a thickness of 0.18 μm.

### Example 2-7

An electrophotographic photosensitive member in Example 2-7 was prepared in the same manner as in Example 2-6 except that the amount of Exemplary compound (7) (0.89 parts) used in preparation of the coating solution for a charge generating layer in Example 2-6 was changed to 1.89 parts.

### Example 2-8

An electrophotographic photosensitive member in Example 2-8 was prepared in the same manner as in Example 2-6 except that the amount of Exemplary compound (7) (0.89 parts) used in preparation of the coating solution for a charge generating layer in Example 2-6 was changed to 5.89 parts.

### Example 2-9

The hydroxygallium phthalocyanine crystal prepared in Example 1-1 (charge generating substance) (20 parts) used in preparation of the coating solution for a charge generating layer in Example 2-1 was replaced by the hydroxygallium phthalocyanine crystal prepared in Example 1-5 (charge generating substance) (20 parts). An electrophotographic photosensitive member in Example 2-9 was prepared in the same manner as in Example 2-1 except that Exemplary compound (2-1) (0.2 parts) was replaced by Exemplary compound (2-25) (0.2 parts).

### Example 2-10

The hydroxygallium phthalocyanine crystal prepared in Example 1-5 (charge generating substance) (20 parts) used in preparation of the coating solution for a charge generating layer in Example 2-9 was replaced by the hydroxygallium phthalocyanine crystal prepared in Example 1-5 (charge generating substance) (20 parts). Except that, an electrophotographic photosensitive member in Example 2-10 was prepared in the same manner as in Example 2-9.

### Example 2-11

An electrophotographic photosensitive member in Example 2-11 was prepared in the same manner as in Example 2-1 except that preparation of the coating solution for a charge generating layer in Example 2-1 was changed as follows.

The hydroxygallium phthalocyanine crystal prepared in Example 1-7 (charge generating substance) (20 parts), Exemplary compound (26) (production code: M1624, manufactured by Tokyo Chemical Industry Co., Ltd.) (0.2 parts), polyvinyl butyral (trade name: S-LEC BX-1, manufactured by Sekisui Chemical Co., Ltd.) (10 parts), and cyclohexanone (519 parts) were placed in a sand mill containing glass beads having a diameter of 1 mm, and were dispersed for 4 hours. Subsequently, ethyl acetate (764 parts) was added to prepare a coating solution for a charge generating layer. The coating solution for a charge generating layer was applied onto the undercoat layer by immersion coating to form a coating. The coating was dried at 100° C. for 10 minutes to dispose a charge generating layer having a thickness of 0.18 μm.

### Example 2-12

An electrophotographic photosensitive member in Example 2-12 was prepared in the same manner as in Example 2-11 except that preparation of the coating solution for a charge generating layer in Example 2-11 was changed as follows.

The hydroxy gallium phthalocyanine crystal (charge generating substance) in Example 1-2 (20 parts), Exemplary compound (26) (0.2 parts), Exemplary compound (2-25) (0.001 parts), polyvinyl butyral (trade name: S-LEC BX-1, manufactured by Sekisui Chemical Co., Ltd.) (10 parts) and cyclohexanone (519 parts) were placed in a sand mill containing glass beads having a diameter of 1 mm, and were dispersed for 4 hours. Subsequently, ethyl acetate (764 parts) was added to prepare a coating solution for a charge generating layer. The coating solution for a charge generating layer was applied onto the undercoat layer by immersion coating to form a coating. The coating was dried at 100° C. for 10 minutes to dispose a charge generating layer having a thickness of 0.18 μm.

### Example 2-13

The hydroxygallium phthalocyanine crystal prepared in Example 1-7 (charge generating substance) (20 parts) used in preparation of the coating solution for a charge generating layer in Example 2-11 was replaced by the hydroxygallium phthalocyanine crystal prepared in Example 1-8 (charge generating substance) (20 parts). Except that, an electrophotographic photosensitive member in Example 2-13 was prepared in the same manner as in Example 2-11.

### Example 2-14

The hydroxygallium phthalocyanine crystal prepared in Example 1-7 (charge generating substance) (20 parts) used in preparation of the coating solution for a charge generating layer in Example 2-11 was replaced by the hydroxygallium phthalocyanine crystal prepared in Example 1-9 (charge generating substance) (20 parts). Except that, an electrophotographic photosensitive member in Example 2-14 was prepared in the same manner as in Example 2-11.

### Example 2-15

The hydroxygallium phthalocyanine crystal prepared in Example 1-7 (charge generating substance) (20 parts) used in preparation of the coating solution for a charge generating layer in Example 2-11 was replaced by the hydroxygallium phthalocyanine crystal prepared in Example 1-10 (charge generating substance) (20 parts). Except that, an electrophotographic photosensitive member in Example 2-15 was prepared in the same manner as in Example 2-11.

### Example 2-16

An electrophotographic photosensitive member in Example 2-16 was prepared in the same manner as in Example 2-15 except that preparation of the coating solution for a charge generating layer in Example 2-15 was changed as follows.

The hydroxy gallium phthalocyanine crystal (charge generating substance) in Example 1-10 (20 parts), Exemplary compound (26) (0.2 parts), Exemplary compound (2-25) (1.93 parts), polyvinyl butyral (trade name: S-LEC BX-1, manufactured by Sekisui Chemical Co., Ltd.) (10 parts) and cyclohexanone (519 parts) were placed in a sand mill containing glass beads having a diameter of 1 mm, and were dispersed for 4 hours. Subsequently, ethyl acetate (764 parts) was added to prepare a coating solution for a charge generating layer. The coating solution for a charge generating layer was applied onto the undercoat layer by immersion coating to form a coating. The coating was dried at 100° C. for 10 minutes to dispose a charge generating layer having a thickness of 0.18 μm.

### Example 2-17

Exemplary compound (26) (0.2 parts) used in preparation of the coating solution for a charge generating layer in Example 2-11 was replaced by Exemplary compound (38) (production code: B3930, manufactured by Tokyo Chemical Industry Co., Ltd.) (0.2 parts). Except that, an electrophotographic photosensitive member in Example 2-17 was prepared in the same manner as in Example 2-11.

### Example 2-18

The hydroxygallium phthalocyanine crystal prepared in Example 1-5 (charge generating substance) (20 parts) used in preparation of the coating solution for a charge generating layer in Example 2-9 was replaced by the hydroxygallium phthalocyanine crystal prepared in Example 1-11 (charge generating substance) (20 parts). Except that, an electrophotographic photosensitive member in Example 2-18 was prepared in the same manner as in Example 2-9.

### Example 2-19

Exemplary compound (26) (0.2 parts) used in preparation of the coating solution for a charge generating layer in Example 2-16 was replaced by Exemplary compound (75) (production code: M0561, manufactured by Tokyo Chemical Industry Co., Ltd.) (0.2 parts). Except that, an electrophotographic photosensitive member in Example 2-19 was prepared in the same manner as in Example 2-16.

### Example 2-20

Exemplary compound (7) (0.001 parts) used in preparation of the coating solution for a charge generating layer in Example 2-2 was replaced by Exemplary compound (4) (production code: A0756, manufactured by Tokyo Chemical Industry Co., Ltd.) (0.2 parts). Exemplary compound (2-1) (0.2 parts) was replaced by Exemplary compound (2-3) (0.2 parts). Except that, an electrophotographic photosensitive member in Example 2-20 was prepared in the same manner as in Example 2-2.

### Example 2-21

Exemplary compound (4) (0.2 parts) used in preparation of the coating solution for a charge generating layer in Example 2-20 was replaced by Exemplary compound (24) (production code: D2635, manufactured by Tokyo Chemical Industry Co., Ltd.) (0.2 parts). An electrophotographic photosensitive member in Example 2-21 was prepared in the same manner as in Example 2-20 except that Exemplary compound (2-3) (0.2 parts) was replaced by Exemplary compound (2-22) (0.2 parts).

### Example 2-22

The hydroxy gallium phthalocyanine crystal (charge generating substance) prepared in Example 1-10 (20 parts) used in preparation of the coating solution for a charge generating layer in Example 2-19 was replaced by the hydroxy gallium phthalocyanine crystal (charge generating substance) prepared in Example 1-12 (20 parts). An electrophotographic photosensitive member in Example 2-22 was prepared in the same manner as in Example 2-19 except that Exemplary compound (75) (0.2 parts) was replaced by Exemplary compound (51) (product code: H0360, manufactured by Tokyo Chemical Industry Co., Ltd.) (0.2 parts).

### Example 2-23

Exemplary compound (4) (0.2 parts) used in preparation of the coating solution for a charge generating layer in Example 2-20 was replaced by Exemplary compound (69) (production code: A1398, manufactured by Tokyo Chemical Industry Co., Ltd.) (0.2 parts). An electrophotographic photosensitive member in Example 2-23 was prepared in the same manner as in Example 2-20 except that Exemplary compound (2-3) (0.2 parts) was replaced by Exemplary compound (3-2) (0.2 parts).

### Example 2-24

Exemplary compound (4) (0.2 parts) used in preparation of the coating solution for a charge generating layer in Example 2-20 was replaced by Exemplary compound (76) (production code: D1319, manufactured by Tokyo Chemical Industry Co., Ltd.) (0.2 parts). An electrophotographic photosensitive member in Example 2-24 was prepared in the same manner as in Example 2-20 except that Exemplary compound (2-3) (0.2 parts) was replaced by Exemplary compound (3-23) (0.2 parts).

### Example 2-25

The hydroxy gallium phthalocyanine crystal (charge generating substance) prepared in Example 1-5 (20 parts) used in preparation of the coating solution for a charge generating layer in Example 2-9 was replaced by the hydroxy gallium phthalocyanine crystal (charge generating substance) in Example 1-13 (20 parts). Except that, an electrophotographic photosensitive member in Example 2-25 was prepared in the same manner as in Example 2-9.

### Example 2-26

The hydroxygallium phthalocyanine crystal prepared in Example 1-13 (charge generating substance) (20 parts) used in preparation of the coating solution for a charge generating layer in Example 2-25 was replaced by the hydroxygallium phthalocyanine crystal prepared in Example 1-14 (charge generating substance) (20 parts). An electrophotographic photosensitive member in Example 2-26 was prepared in the same manner as in Example 2-25 except that Exemplary compound (2-25) (0.2 parts) was replaced by Exemplary compound (2-5) (0.2 parts).

### Example 2-27

The hydroxygallium phthalocyanine crystal prepared in Example 1-13 (charge generating substance) (20 parts) used in preparation of the coating solution for a charge generating layer in Example 2-25 was replaced by the hydroxygallium phthalocyanine crystal prepared in Example 1-15 (charge generating substance) (20 parts). An electrophotographic photosensitive member in Example 2-27 was prepared in the same manner as in Example 2-25 except that Exemplary compound (2-25) (0.2 parts) was replaced by Exemplary compound (3-11) (0.2 parts).

### Example 2-28

The hydroxygallium phthalocyanine crystal prepared in Example 1-13 (charge generating substance) (20 parts) used in preparation of the coating solution for a charge generating layer in Example 2-25 was replaced by the hydroxygallium phthalocyanine crystal prepared in Example 1-16 (charge generating substance) (20 parts). An electrophotographic photosensitive member in Example 2-28 was prepared in the same manner as in Example 2-25 except that Exemplary compound (2-25) (0.2 parts) was replaced by Exemplary compound (2-10) (0.2 parts).

### Example 2-29

Exemplary compound (4) (0.2 parts) used in preparation of the coating solution for a charge generating layer in Example 2-20 was replaced by Exemplary compound (54) (production code: B2252, manufactured by Tokyo Chemical Industry Co., Ltd.) (0.2 parts). An electrophotographic photosensitive member in Example 2-29 was prepared in the same manner as in Example 2-20 except that Exemplary compound (2-3) (0.2 parts) was replaced by Exemplary compound (2-13) (0.2 parts).

### Example 2-30

An electrophotographic photosensitive member in Example 2-30 was prepared in the same manner as in Example 2-1 except that preparation of the coating solution for a charge generating layer in Example 2-1 was changed as follows.

The chlorogallium phthalocyanine pigment prepared in Synthesis Example 2 (charge generating substance) (20 parts), Exemplary compound (57) (production code: E0732, manufactured by Tokyo Chemical Industry Co., Ltd.) (0.2 parts), Exemplary compound (2-25) (0.2 parts), polyvinyl butyral (trade name: S-LEC BX-1, manufactured by Sekisui Chemical Co., Ltd.) (10 parts), and cyclohexanone (519 parts) were placed in a sand mill containing glass beads having a diameter of 1 mm, and were dispersed for 4 hours. Subsequently, ethyl acetate (764 parts) was added to prepare a coating solution for a charge generating layer. The coating solution for a charge generating layer was applied onto the undercoat layer by immersion coating to form a coating. The coating was dried at 100° C. for 10 minutes to dispose a charge generating layer having a thickness of 0.27 μm.

### Example 2-31

Exemplary compound (57) (0.2 parts) used in preparation of the coating solution for a charge generating layer in Example 2-30 was replaced by Exemplary compound (2-7) (0.2 parts) and Exemplary compound (2-25) (0.2 parts) was replaced by Exemplary compound (2-17) (0.2 parts). Except these, an electrophotographic photosensitive member in Example 2-31 was prepared in the same manner as in Example 2-30.

### Example 2-32

Exemplary compound (75) (0.2 parts) used in preparation of the coating solution for a charge generating layer in Example 2-19 was replaced by Exemplary compound (85) (production code: C1231, manufactured by Tokyo Chemical Industry Co., Ltd.) (0.2 parts). Except that, an electrophotographic photosensitive member in Example 2-32 was prepared in the same manner as in Example 2-19.

### Example 2-33

Exemplary compound (4) (0.2 parts) used in preparation of the coating solution for a charge generating layer in Example 2-20 was replaced by Exemplary compound (163) (production code: B2805, manufactured by Tokyo Chemical Industry Co., Ltd.) (0.2 parts). An electrophotographic photosensitive member in Example 2-33 was prepared in the same manner as in Example 2-20 except that Exemplary compound (2-3) (0.2 parts) was replaced by Exemplary compound (3-14) (0.2 parts).

### Example 2-34

Exemplary compound (4) (0.2 parts) used in preparation of the coating solution for a charge generating layer in Example 2-20 was replaced by Exemplary compound (100) (production code: N0584, manufactured by Tokyo Chemical Industry Co., Ltd.) (0.2 parts). An electrophotographic photosensitive member in Example 2-34 was prepared in the same manner as in Example 2-20 except that Exemplary compound (2-3) (0.2 parts) was replaced by Exemplary compound (3-25) (0.2 parts).

### Example 2-35

Exemplary compound (4) (0.2 parts) used in preparation of the coating solution for a charge generating layer in Example 2-20 was replaced by Exemplary compound (5) (production code: C1040, manufactured by Tokyo Chemical Industry Co., Ltd.) (0.2 parts). An electrophotographic photosensitive member in Example 2-35 was prepared in the same manner as in Example 2-20 except that Exemplary compound (2-3) (0.2 parts) was replaced by Exemplary compound (2-19) (0.2 parts).

### Example 2-36

Exemplary compound (4) (0.2 parts) used in preparation of the coating solution for a charge generating layer in Example 2-20 was replaced by Exemplary compound (53) (production code: P1513, manufactured by Tokyo Chemical Industry Co., Ltd.) (0.2 parts). An electrophotographic photosensitive member in Example 2-36 was prepared in the same manner as in Example 2-20 except that Exemplary compound (2-3) (0.2 parts) was replaced by Exemplary compound (3-13) (0.2 parts).

### Example 2-37

Exemplary compound (26) (0.2 parts) used in preparation of the coating solution for a charge generating layer in Example 2-11 was replaced by Exemplary compound (117) (production code: P2030, manufactured by Tokyo Chemical Industry Co., Ltd.) (0.2 parts). Except that, an electrophotographic photosensitive member in Example 2-37 was prepared in the same manner as in Example 2-11.

### Example 2-38

Exemplary compound (4) (0.2 parts) used in preparation of the coating solution for a charge generating layer in Example 2-20 was replaced by Exemplary compound (131) (production code: C1646, manufactured by Tokyo Chemical Industry Co., Ltd.) (0.2 parts). An electrophotographic photosensitive member in Example 2-38 was prepared in the same manner as in Example 2-20 except that Exemplary compound (2-3) (0.2 parts) was replaced by Exemplary compound (3-27) (0.2 parts).

### Example 2-39

Exemplary compound (51) (0.2 parts) used in preparation of the coating solution for a charge generating layer in Example 2-22 was replaced by Exemplary compound (141) (production code: M0686, manufactured by Tokyo Chemical Industry Co., Ltd.) (0.2 parts). Except that, an electrophotographic photosensitive member in Example 2-39 was prepared in the same manner as in Example 2-22.

### Example 2-40

Exemplary compound (4) (0.2 parts) used in preparation of the coating solution for a charge generating layer in Example 2-20 was replaced by Exemplary compound (138) (production code: B1339, manufactured by Tokyo Chemical Industry Co., Ltd.) (0.2 parts). An electrophotographic photosensitive member in Example 2-40 was prepared in the same manner as in Example 2-20 except that Exemplary compound (2-3) (0.2 parts) was replaced by Exemplary compound (3-30) (0.2 parts).

### Comparative Example 2-1

The hydroxygallium phthalocyanine crystal prepared in Example 1-1 (charge generating substance) (20 parts) used in preparation of the coating solution for a charge generating layer in Example 2-1 was replaced by the hydroxygallium phthalocyanine crystal prepared in Example 1-2 (charge generating substance) (20 parts). Except that Exemplary compound (2-1) (0.2 parts) was not used, an electrophotographic photosensitive member in Comparative Example 2-1 was prepared in the same manner as in Example 2-1.

### Comparative Example 2-2

The hydroxygallium phthalocyanine crystal prepared in Example 1-1 (charge generating substance) (20 parts) used in preparation of the coating solution for a charge generating layer in Example 2-1 was replaced by the hydroxygallium phthalocyanine crystal prepared in Example 1-2 (charge generating substance) (20 parts). Except that, an electrophotographic photosensitive member in Comparative Example 2-2 was prepared in the same manner as in Example 2-1.

### Comparative Example 2-3

Except that Exemplary compound (0.2 parts) used in preparation of the coating solution for a charge generating layer in Example 2-1 was not used, an electrophotographic photosensitive member in Comparative Example 2-3 was prepared in the same manner as in Example 2-1.

### Comparative Example 2-4

The hydroxygallium phthalocyanine crystal prepared in Example 1-1 (charge generating substance) (20 parts) used in preparation of the coating solution for a charge generating layer in Example 2-1 was replaced by the hydroxygallium phthalocyanine crystal prepared in Comparative Example 1-1 (charge generating substance) (20 parts). Except that, an electrophotographic photosensitive member in Comparative Example 2-4 was prepared in the same manner as in Example 2-1.

### Comparative Example 2-5

An electrophotographic photosensitive member in Comparative Example 2-5 was prepared in the same manner as in Example 2-1 except that preparation of the coating solution for a charge generating layer in Example 2-1 was changed as follows.

A bisazo pigment represented by Formula (11) (20 parts), Exemplary compound (7) (0.2 parts), Exemplary compound (2-1) (0.2 parts), polyvinyl butyral (trade name: S-LEC BX-1, manufactured by Sekisui Chemical Co., Ltd.) (8 parts), and cyclohexanone (380 parts) were placed in a sand mill containing glass beads having a diameter of 0.8 mm, and were dispersed for 20 hours. Subsequently, ethyl acetate (640 parts) was added to prepare a coating solution for a charge generating layer. The coating solution for a charge generating layer was applied onto the undercoat layer by immersion coating to form a coating. The coating was dried at 80° C. for 10 minutes to dispose a charge generating layer having a thickness of 0.28 μm.

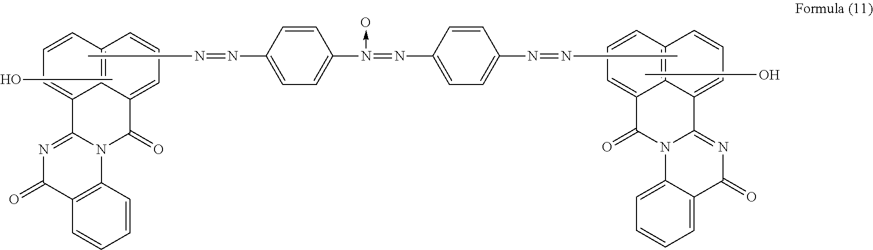

### Evaluation of Examples 2-1 to 2-40 and Comparative Examples 2-1 to 2-5

The electrophotographic photosensitive members in Examples 2-1 to 2-40 and Comparative Examples 2-1 to 2-5 were evaluated.

As an electrophotographic apparatus for evaluation, a laser beam printer LaserJet 4700 manufactured by Hewlett-Packard Company which was modified to enable evaluation of black spots, fogging and unevenness of density was used. A dark potential was set to be −700 V.

The electrophotographic photosensitive member prepared was left under a high temperature and high humidity environment at 32.5° C./80% RH for 24 hours. Subsequently, the electrophotographic photosensitive member was mounted on a cyan process cartridge for the laser beam printer, and the process cartridge was mounted on a station for the cyan process cartridge in the laser beam printer. The laser beam printer was modified to operate without mounting the process cartridges for other colors on the main body of the laser beam printer, and an image for evaluation was output under the same environment.

A solid white image was output on a glossy paper, and presence of defects on the output image was visually observed to evaluate black spots and fogging. The results were ranked from A to F. Rank A refers to an image having no black spots, and Rank F refers to an image having black spots all over the image. Rank B refers to an image having 1 to 2 black spots having a diameter (φ) of 0.3 mm or less in a region corresponding to one circumference of the electrophotographic photosensitive member. Rank C refers to an image having 3 to 4 black spots having a diameter (φ) of 0.3 mm or less in a region corresponding to one circumference of the electrophotographic photosensitive member. Rank D refers to an image having 5 to 10 black spots having a diameter (φ) of 0.3 mm or less in a region corresponding to one circumference of the electrophotographic photosensitive member. Rank E refers to an image having 11 to 20 black spots having a diameter (φ) of 0.3 mm or less in a region corresponding to one circumference of the electrophotographic photosensitive member.

Among these, it was determined that the effect of the present invention is not sufficiently attained in Ranks E and F.

In evaluation of unevenness of density, the dot density of a halftone image was set at 1 dot and 1 space, and the halftone image was output. A visual examination was performed on the output image.

The results of evaluation are shown in Table 1.

TABLE 1

| | Evaluation on | Evaluation on |
|---|---|---|
| | black spots and | unevenness of |
| | fogging | density |
| Example 2-1 | A | Good |
| Example 2-2 | D | Good |
| Example 2-3 | C | Good |
| Example 2-4 | A | Good |
| Example 2-5 | A | Very good |
| Example 2-6 | A | Good |
| Example 2-7 | B | Good |
| Example 2-8 | C | Good |
| Example 2-9 | A | Good |
| Example 2-10 | A | Good |
| Example 2-11 | A | Very good |
| Example 2-12 | C | Good |
| Example 2-13 | B | Very good |
| Example 2-14 | A | Very good |
| Example 2-15 | A | Very good |
| Example 2-16 | C | Good |
| Example 2-17 | A | Very good |
| Example 2-18 | A | Good |
| Example 2-19 | A | Very good |
| Example 2-20 | B | Good |
| Example 2-21 | B | Good |
| Example 2-22 | B | Very good |
| Example 2-23 | B | Good |
| Example 2-24 | B | Good |
| Example 2-25 | A | Good |
| Example 2-26 | B | Good |
| Example 2-27 | B | Good |
| Example 2-28 | C | Good |
| Example 2-29 | D | Good |
| Example 2-30 | D | Good |
| Example 2-31 | D | Good |
| Example 2-32 | B | Very good |
| Example 2-33 | C | Good |
| Example 2-34 | C | Good |
| Example 2-35 | C | Good |
| Example 2-36 | D | Good |
| Example 2-37 | C | Very good |
| Example 2-38 | D | Good |
| Example 2-39 | C | Very good |
| Example 2-40 | D | Good |
| Comparative Example 2-1 | F | Uneven |
| Comparative Example 2-2 | F | Good |
| Comparative Example 2-3 | E | Uneven |
| Comparative Example 2-4 | E | Good |
| Comparative Example 2-5 | F | Uneven |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-204604, filed Sep. 30, 2013, which is hereby incorporated by reference herein in its entirety.

What is claimed is:

1. An electrophotographic photosensitive member comprising:
a support;
a charge generating layer on the support; and
a charge transporting layer on the charge generating layer,
wherein the charge generating layer comprises:
a gallium phthalocyanine crystal;
a nitrogen-containing heterocyclic compound; and
a compound represented by Formula (1) or a compound represented by Formula (2); 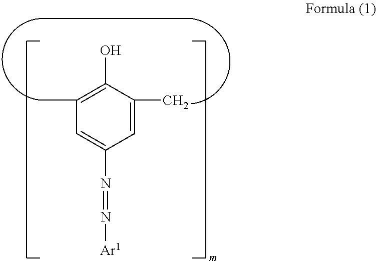
wherein,
m represents an integer of 4 to 8;
m pieces of Ar¹ may be identical or different from each other, and represent a substituted or unsubstituted aromatic hydrocarbon ring, a substituted or unsubstituted heterocyclic ring, or a monovalent group formed by bonding a plurality of groups selected from the group consisting of a substituted aromatic hydrocarbon ring, an unsubstituted aromatic hydrocarbon ring, a substituted heterocyclic ring, and an unsubstituted heterocyclic ring, or 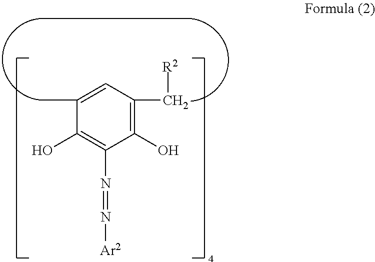
wherein,
four pieces of R² may be identical or different from each other, and represent a hydrogen atom, or a substituted or unsubstituted alkyl group;
four pieces of Ar² may be identical or different from each other, and represent a substituted or unsubstituted aromatic hydrocarbon ring, a substituted or unsubstituted heterocyclic ring, or a monovalent group formed by bonding a plurality of groups selected from the group consisting of a substituted aromatic hydrocarbon ring, an unsubstituted aromatic hydrocarbon ring, a substituted heterocyclic ring, and an unsubstituted heterocyclic ring,
and wherein a nitrogen atom in a heterocyclic ring of the nitrogen-containing heterocyclic compound has a substituent, wherein the substituent is a substituted or unsubstituted acyl group, —(C═O)—O—R¹, a substituted or unsubstituted alkyl group, a substituted or unsubstituted alkenyl group, a substituted or unsubstituted aryl group, or a substituted or unsubstituted heterocyclic group,
a substituent of the substituted acyl group is a substituted or unsubstituted alkyl group, a substituted or unsubstituted alkenyl group, a substituted or unsubstituted aryl group, or a substituted or unsubstituted heterocyclic group; R¹ represents a substituted or unsubstituted alkyl group, a substituted or unsubstituted alkenyl group, a substituted or unsubstituted aryl group, or a substituted or unsubstituted heterocyclic group; and
a substituent of the substituted alkyl group, a substituent of the substituted alkenyl group, a substituent of the substituted aryl group, and a substituent of the substituted heterocyclic group are a halogen atom, a cyano group, a nitro group, a hydroxy group, a formyl group, an alkyl group, an alkenyl group, an alkoxy group, or an aryl group.

2. The electrophotographic photosensitive member according to claim 1, wherein the nitrogen-containing heterocyclic compound is pyrrole, pyrrolidine, morpholine, piperazine, piperidine, 4-piperidone, indole, phenothiazine, phenoxazine or carbazole.

3. The electrophotographic photosensitive member according to claim 1, wherein the substituent bonding to an atom other than the nitrogen atom that forms the ring of the nitrogen-containing heterocyclic compound is a hydrogen atom, a substituted or unsubstituted alkyl group, a substituted or unsubstituted aryl group, a substituted or unsubstituted heterocyclic group, a halogen atom, a hydroxy group, a formyl group, an alkenyl group, an alkoxy group or an alkyloxycarbonyl group,
wherein a substituent of the substituted alkyl group, a substituent of the substituted aryl group and a substituent of the substituted heterocyclic group are a halogen atom, a hydroxy group or a formyl group.

4. The electrophotographic photosensitive member according to claim 1, wherein the nitrogen-containing heterocyclic compound is a compound represented by Formula (3): 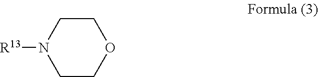
wherein R¹³ represents a substituted or unsubstituted acyl group, —(C═O)—O—R¹¹, a substituted or unsubstituted alkyl group, a substituted or unsubstituted alkenyl group, a substituted or unsubstituted aryl group or a substituted or unsubstituted heterocyclic group; a substituent of the substituted acyl group is a substituted or unsubstituted alkyl group, a substituted or unsubstituted alkenyl group, a substituted or unsubstituted aryl group, or a substituted or unsubstituted heterocyclic group; R¹¹ represents a substituted or unsubstituted alkyl group, a substituted or unsubstituted alkenyl group, a substituted or unsubstituted aryl group, or a substituted or unsubstituted heterocyclic group;
wherein a substituent of the substituted alkyl group, a substituent of the substituted alkenyl group, a substituent of the substituted aryl group and a substituent of the substituted heterocyclic group are a halogen atom, a cyano group, a nitro group, a hydroxy group, a formyl group, an alkyl group, an alkenyl group, an alkoxy group or an aryl group.

5. The electrophotographic photosensitive member according to claim 4, wherein R¹³ in Formula (3) is a methyl group, an ethyl group or a phenyl group.

6. The electrophotographic photosensitive member according to claim 1, wherein the nitrogen-containing heterocyclic compound is a compound represented by Formula (4): 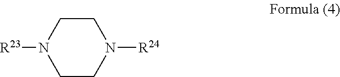
wherein R²³ and R²⁴ each independently represent a substituted or unsubstituted acyl group, —(C═O)—O—R²¹, a substituted or unsubstituted alkyl group, a substituted or unsubstituted alkenyl group, a substituted or unsubstituted aryl group or a substituted or unsubstituted heterocyclic group; a substituent of the substituted acyl group is a substituted or unsubstituted alkyl group, a substituted or unsubstituted alkenyl group, a substituted or unsubstituted aryl group or a substituted or unsubstituted heterocyclic group; R²¹ represents a substituted or unsubstituted alkyl group, a substituted or unsubstituted alkenyl group, a substituted or unsubstituted aryl group or a substituted or unsubstituted heterocyclic group;
wherein a substituent of the substituted alkyl group, a substituent of the substituted alkenyl group, a substituent of the substituted aryl group and a substituent of the substituted heterocyclic group are a halogen atom, a cyano group, a nitro group, a hydroxy group, a formyl group, an alkyl group, an alkenyl group, an alkoxy group or an aryl group.

7. The electrophotographic photosensitive member according to claim 6, wherein R²³ and R²⁴ in Formula (4) are each independently a methyl group, an ethyl group or a phenyl group.

8. The electrophotographic photosensitive member according to claim 1, wherein the nitrogen-containing heterocyclic compound is a compound represented by Formula (5): 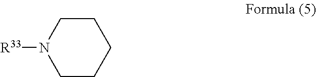
wherein R³³ represents a substituted or unsubstituted acyl group, —(C═O)—O—R³¹, a substituted or unsubstituted alkyl group, a substituted or unsubstituted alkenyl group, a substituted or unsubstituted aryl group or a substituted or unsubstituted heterocyclic group; a substituent of the substituted acyl group is a substituted or unsubstituted alkyl group, a substituted or unsubstituted alkenyl group, a substituted or unsubstituted aryl group or a substituted or unsubstituted heterocyclic group; R³¹ represents a substituted or unsubstituted alkyl group, a substituted or unsubstituted alkenyl group, a substituted or unsubstituted aryl group or a substituted or unsubstituted heterocyclic group;
wherein a substituent of the substituted alkyl group, a substituent of the substituted alkenyl group, a substituent of the substituted aryl group and a substituent of the substituted heterocyclic group are a halogen atom, a cyano group, a nitro group, a hydroxy group, a formyl group, an alkyl group, an alkenyl group, an alkoxy group or an aryl group.

9. The electrophotographic photosensitive member according to claim 8, wherein R³³ in Formula (5) is a methyl group, an ethyl group or a phenyl group.

10. The electrophotographic photosensitive member according to claim 1, wherein the nitrogen-containing heterocyclic compound is a compound represented by Formula (6): 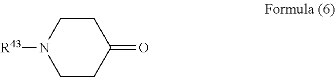
wherein R⁴³ represents a substituted or unsubstituted acyl group, —(C═O)—O—R⁴¹, a substituted or unsubstituted alkyl group, a substituted or unsubstituted alkenyl group, a substituted or unsubstituted aryl group or a substituted or unsubstituted heterocyclic group; a substituent of the substituted acyl group is a substituted or unsubstituted alkyl group, a substituted or unsubstituted alkenyl group, a substituted or unsubstituted aryl group or a substituted or unsubstituted heterocyclic group; R⁴¹ represents a substituted or unsubstituted alkyl group, a substituted or unsubstituted alkenyl group, a substituted or unsubstituted aryl group or a substituted or unsubstituted heterocyclic group;
wherein a substituent of the substituted alkyl group, a substituent of the substituted alkenyl group, a substituent of the substituted aryl group and a substituent of the substituted heterocyclic group are a halogen atom, a cyano group, a nitro group, a hydroxy group, a formyl group, an alkyl group, an alkenyl group, an alkoxy group or an aryl group.

11. The electrophotographic photosensitive member according to claim 10, wherein R⁴³ in Formula (6) is a methyl group, an ethyl group or a phenyl group.

12. The electrophotographic photosensitive member according to claim 1, wherein the nitrogen-containing heterocyclic compound is a compound represented by Formula (7): 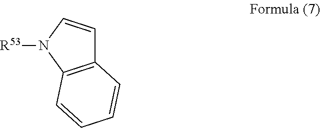
wherein R⁵³ represents a substituted or unsubstituted acyl group, —(C═O)—O—R⁵¹, a substituted or unsubstituted alkyl group, a substituted or unsubstituted alkenyl group, a substituted or unsubstituted aryl group, or a substituted or unsubstituted heterocyclic group; a substituent of the substituted acyl group is a substituted or unsubstituted alkyl group, a substituted or unsubstituted alkenyl group, a substituted or unsubstituted aryl group, or a substituted or unsubstituted heterocyclic group; R⁵¹ represents a substituted or unsubstituted alkyl group, a substituted or unsubstituted alkenyl group, a substituted or unsubstituted aryl group, or a substituted or unsubstituted heterocyclic group;
wherein a substituent of the substituted alkyl group, a substituent of the substituted alkenyl group, a substituent of the substituted aryl group and a substituent of the substituted heterocyclic group are a halogen atom, a cyano group, a nitro group, a hydroxy group, a formyl group, an alkyl group, an alkenyl group, an alkoxy group, or an aryl group.

13. The electrophotographic photosensitive member according to claim 1, wherein a content of the nitrogen-containing heterocyclic compound in the charge generating layer is 0.01% by mass or more and 20% by mass or less based on the gallium phthalocyanine crystal.

14. The electrophotographic photosensitive member according to claim 1, wherein the gallium phthalocyanine crystal is a gallium phthalocyanine crystal in which the nitrogen-containing heterocyclic compound is contained.

15. The electrophotographic photosensitive member according to claim 1, wherein a content of the compound represented by Formula (1) or (2) in the charge generating layer is 0.01% by mass or more and 5% by mass or less based on the gallium phthalocyanine crystal.

16. The electrophotographic photosensitive member according to claim 1, wherein the gallium phthalocyanine crystal is a gallium phthalocyanine crystal in which the compound represented by Formula (1) or (2) is contained.

17. The electrophotographic photosensitive member according to claim 1, wherein Ar¹ in Formula (1) and Ar² in Formula (2) are a phenyl group substituted by at least one group selected from the group consisting of a cyano group, a nitro group and a halogen atom.

18. The electrophotographic photosensitive member according to claim 1, wherein the gallium phthalocyanine crystal is a hydroxygallium phthalocyanine crystal in a crystal form having peaks at Bragg angles 20 of 7.4°±0.3° and 28.2°±0.3° in X-ray diffraction with CuKa radiation.

19. A process cartridge detachably mountable on a main body of an electrophotographic apparatus, the process cartridge comprising the electrophotographic photosensitive member according to claim 1 and at least one unit selected from the group consisting of a charging unit, a developing unit, a transferring unit and a cleaning unit, the electrophotographic photosensitive member according to claim 1 and the at least one unit being integrally supported.

20. An electrophotographic apparatus, comprising the electrophotographic photosensitive member according to claim 1, a charging unit, an image exposing unit, a developing unit and a transferring unit.
